(19) United States
(12) Patent Application Publication
(10) Pub. No.: US 2026/0195210 A1
(43) Pub. Date: Jul. 9, 2026

(54) INFORMATION PROCESSING METHOD AND INFORMATION PROCESSING SYSTEM

(71) Applicant: Fujitsu Limited, Kawasaki-shi (JP)

(72) Inventors: Takumi SAKAI, Ota (JP); Daiki YOSHIKAWA, Handa (JP)

(73) Assignee: Fujitsu Limited, Kawasaki-shi (JP)

(21) Appl. No.: 19/431,135

(22) Filed: Dec. 23, 2025

(30) Foreign Application Priority Data
Jan. 9, 2025 (JP) 2025-003790

(51) Int. Cl. G06F 11/07

(52) U.S. Cl. CPC G06F 11/079; G06F 11/0709

(57) ABSTRACT

An information processing apparatus acquires a message including a job name of a job in which a trouble has occurred and type information indicating a type of the trouble. The information processing apparatus determines an impact level of the trouble on a system executing the job, based on a combination of the job name and the type information. The information processing apparatus determines an attribute of information to be acquired, based on the determined impact level. Then, the information processing apparatus acquires, from first information relating to the job, second information having the determined attribute.

### CROSS-REFERENCE TO RELATED APPLICATION

This application is based upon and claims the benefit of priority of the prior Japanese Patent Application No. 2025-003790, filed on Jan. 9, 2025, the entire contents of which are incorporated herein by reference.

### FIELD

The embodiments discussed herein relate to an information processing method and an information processing system.

### BACKGROUND

In recent years, in order to quickly respond to business growth and changes, digital services (such as demand forecasting and logistics cost optimization) that integrate various cloud computing systems (Hereinafter, referred to as cloud systems) with on-premise assets have been expanding. The operation of such digital services involves a complex interrelation among a large number of cloud systems and on-premise assets. Therefore, failures may occur due to various causes. In order to analyze the causes of such failures efficiently, it is important to appropriately acquire information on the failures.

As a technique related to the collection of failure information, for example, there has been proposed a log collection method for accomplishing highly efficient failure cause identification with downtime minimized. Further, there has been proposed a failure investigation information material collection system that enables appropriate collection of materials needed to identify the causes of failures according to the attributes of the failures. Still further, there has been proposed a control method for obtaining log data useful for investigating the causes of errors with a small amount of data. Still further, there has been proposed a log control apparatus that is able to efficiently store logs useful for failure analysis. See, for example, the following literatures.
Japanese Laid-open Patent Publication No. 2021-125757
Japanese Laid-open Patent Publication No. 2012-181699
Japanese Laid-open Patent Publication No. 2009-230301
Japanese Laid-open Patent Publication No. 2008-9854

### SUMMARY

In one embodiment, there is provided a non-transitory computer-readable storage medium storing a computer program that causes a computer to perform a process including: acquiring a message including a job name of a job in which a trouble has occurred and type information indicating a type of the trouble; determining an impact level of the trouble on a system executing the job, based on a combination of the job name and the type information; determining an attribute of information to be acquired, based on the determined impact level; and acquiring, from first information relating to the job, second information having the determined attribute.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing method according to a first embodiment;

FIG. 2 illustrates an example of a system configuration according to a second embodiment;

FIG. 3 illustrates an example of the hardware of a job management server;

FIG. 4 illustrates an example procedure for trouble handling when a trouble occurs;

FIG. 5 is a block diagram illustrating an example of the functions of a job management server;

FIG. 6 illustrates an example of a process flow from occurrence of a trouble to issuance of an incident;

FIG. 7 illustrates an example of a job flow management table;

FIG. 8 illustrates an example of a state-specific job count record table;

FIG. 9 illustrates an example of a job execution history table;

FIG. 10 illustrates an example of an impact level management table;

FIG. 11 illustrates an example of a handling method management table;

FIG. 12 illustrates an example procedure for a trouble type identification process;

FIG. 13 illustrates an example of an impact level determination process;

FIG. 14 illustrates an example of an information collection range determination process;

FIG. 15 illustrates an example of an information collection process;

FIG. 16 illustrates an example of information collection for a trouble having a trouble type of “Abnormal End” and an impact level of “Low”;

FIG. 17 illustrates an example of information collection for a trouble having the trouble type of “Abnormal End” and an impact level of “Medium”;

FIG. 18 illustrates an example of information collection for a trouble having the trouble type of “Abnormal End” and an impact level of “High”;

FIG. 19 illustrates an example of information collection for a trouble having a trouble type of “Start Delay” and the impact level of “High”;

FIG. 20 illustrates an example of an assumed start delay factor analysis;

FIG. 21 illustrates an example of information collection for a trouble having a trouble type of End Delay and the impact level of “High”;

FIG. 22 illustrates an example of an assumed end delay factor analysis;

FIG. 23 illustrates an example of information collection for a trouble having a trouble type of “Execution Rejection” and the impact level of “High”;

FIG. 24 illustrates an example of an assumed execution rejection factor analysis;

FIG. 25 illustrates an example of information collection for a trouble having a trouble type of “Execution Skip” and the impact level of “High”;

FIG. 26 illustrates an example of an error alert message for each trouble type;

FIG. 27 is a flowchart illustrating an example procedure for an incident monitoring process;

FIG. 28 illustrates an example of trouble information;

FIG. 29 is a flowchart illustrating an example procedure for a trouble type acquisition process;

FIG. 30 illustrates an example of trouble information in which a type code is set;

FIG. 31 is a flowchart illustrating an example procedure for an impact level acquisition process;

FIG. 32 illustrates an example of trouble information in which an impact level is set;

FIG. 33 is a flowchart illustrating an example procedure for an information collection range determination process;

FIG. 34 illustrates examples of trouble information in which an information collection range for the trouble type of “Abnormal End” is set;

FIG. 35 illustrates examples of trouble information in which an information collection range for the trouble type of “Start Delay” is set;

FIG. 36 illustrates examples of trouble information in which an information collection range for the trouble type of “End Delay” is set;

FIG. 37 illustrates examples of trouble information in which an information collection range for the trouble type of “Execution Rejection” is set;

FIG. 38 illustrates examples of trouble information in which an information collection range for the trouble type of “Execution Skip” is set;

FIG. 39 is a flowchart illustrating an example procedure for an information collection and handling method analysis process;

FIG. 40 illustrates an example of trouble information in which information collected in common is set;

FIG. 41 is a flowchart illustrating an example procedure for a subsequent job information acquisition process;

FIG. 42 illustrates an example of response data returned in response to a related job name acquisition command;

FIG. 43 illustrates an example of trouble information in which subsequent job information is set;

FIG. 44 is a flowchart illustrating an example procedure for a third data group collection process;

FIG. 45 illustrates an example of trouble information in which a third data group is set;

FIG. 46 is a flowchart illustrating an example procedure for a sixth data group collection process;

FIG. 47 illustrates an example of trouble information in which a sixth data group is set;

FIG. 48 is a flowchart illustrating an example procedure for a ninth data group collection process;

FIG. 49 illustrates an example of trouble information in which a ninth data group is set;

FIG. 50 is a flowchart illustrating an example procedure for a twelfth data group collection process;

FIG. 51 illustrates an example of trouble information in which a twelfth data group is set;

FIG. 52 is a flowchart illustrating an example procedure for a fifteenth data group collection process;

FIG. 53 illustrates an example of trouble information in which a fifteenth data group is set;

FIG. 54 is a flowchart illustrating an example procedure for a multiplicity acquisition process;

FIG. 55 illustrates an example of response data returned in response to a multiplicity acquisition command;

FIG. 56 is a flowchart illustrating an example procedure for a previous history acquisition process;

FIG. 57 illustrates an example of response data returned in response to an execution history acquisition command;

FIG. 58 is a flowchart illustrating an example procedure for a schedule information acquisition process;

FIG. 59 illustrates an example of response data returned in response to a schedule information acquisition command;

FIG. 60 is a flowchart illustrating an example procedure for an assumed start delay factor analysis process;

FIG. 61 is a flowchart illustrating an example procedure for a first assumed start delay factor analysis process;

FIG. 62 is a flowchart illustrating an example procedure for a second assumed start delay factor analysis process;

FIG. 63 is a flowchart illustrating an example procedure for a third assumed start delay factor analysis process;

FIG. 64 is a flowchart illustrating an example procedure for an assumed end delay factor analysis process;

FIG. 65 is a flowchart illustrating an example procedure for an assumed execution rejection factor analysis process;

FIG. 66 is a flowchart illustrating an example procedure for a first assumed execution rejection factor analysis process;

FIG. 67 is a flowchart illustrating an example procedure for a second assumed execution rejection factor analysis process;

FIG. 68 is a flowchart illustrating an example procedure for a third assumed execution rejection factor analysis process;

FIG. 69 is a flowchart illustrating an example procedure for a fourth assumed execution rejection factor analysis process;

FIG. 70 is a flowchart illustrating an example procedure for a fifth assumed execution rejection factor analysis process;

FIG. 71 illustrates an example of trouble information in which information collected according to a trouble type and an impact level is set; and

FIG. 72 illustrates an example of an incident display screen.

### DESCRIPTION OF EMBODIMENTS

Investigation of troubles in jobs executed in a cloud system or an on-premises asset needs a considerable amount of time. For example, in the case where a message reporting a job trouble is output, an investigation is conducted from a perspective that differs depending on the type of the trouble indicated in the message. If the investigation perspective differs, information useful for the investigation and countermeasure consideration also differs. However, conventionally, it has been difficult to appropriately collect only useful information while taking into account trouble type. Therefore, for example, a large amount of information, including information that is not useful for the investigation and countermeasure consideration, is collected. As a result, it takes time to confirm the content of the collected information, thereby prolonging the time for the investigation and countermeasure consideration.

Hereinafter, embodiments will be described with reference to the drawings. It is to be noted that a plurality of embodiments may be combined unless they exclude each other.

### First Embodiment

A first embodiment relates to an information processing method for automatically collecting information useful for an investigation of a trouble, according to the type of the trouble.

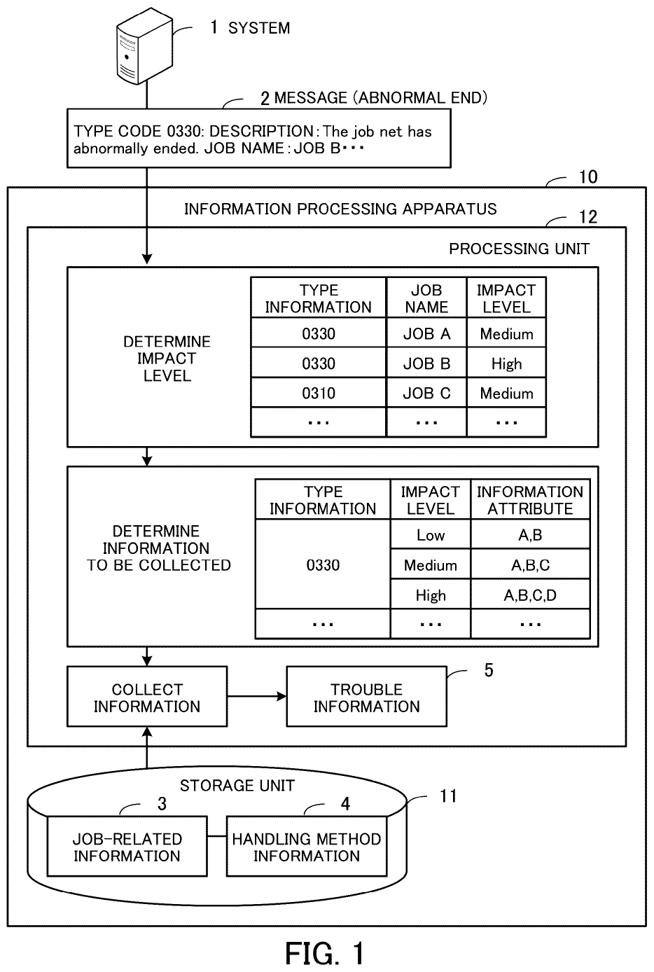

FIG. 1 illustrates an example of the information processing method according to the first embodiment. FIG. 1 illustrates an information processing system for implementing the information processing method. The information processing system includes a system 1 to be managed and an information processing apparatus 10 that manages the system 1. The information processing apparatus 10 is able to implement the information processing method according to the first embodiment by, for example, executing a predetermined information processing program.

The information processing apparatus 10 includes a storage unit 11 and a processing unit 12. The storage unit 11 is, for example, a memory or a storage device included in the information processing apparatus 10. The processing unit 12 is, for example, a processor included in the information processing apparatus 10. The information processing apparatus 10 may include a plurality of processors. Among a plurality of processes performed by the information processing apparatus 10, different processes may be performed by different processors.

The storage unit 11 stores, for example, job-related information 3 relating to jobs, which are executed in the system 1, and handling method information 4 indicating handling methods for troubles. The job-related information 3 includes a job flow indicating a sequence of jobs to be executed, a job execution schedule, a job execution history, and others. The handling method information 4 includes, for example, for each trouble type, information on handling methods for troubles belonging to that trouble type.

When a trouble related to the execution of a job occurs in the system 1 executing the job, the processing unit 12 collects information based on a message 2 indicating the trouble. For example, the processing unit 12 collects the information in accordance with the following procedure.

The processing unit 12 receives, from the system 1, the message 2 including the job name of the job in which the trouble has occurred and type information indicating the type of the trouble. In the example of FIG. 1, the message 2 includes a type code indicating the type of the trouble, as the type information.

The processing unit 12 determines the impact level of the trouble on the system 1 executing the job, based on the combination of the job name and type information indicated in the message 2. For example, an impact level for each possible combination of type information indicating a trouble type and a job name is set in the information processing program executed by the processing unit 12. The correspondence between each combination of type information and a job name, and the impact level may be managed using, for example, a data table. The processing unit 12 determines that the impact level preset in association with the combination of the job name and the type information indicated in the message 2 is the impact level of the trouble that has caused the occurrence of the message 2.

The determined impact level is any one of a plurality of stepwise values such as “High”, “Medium”, and “Low”. In this case, the impact level “High” is the greatest, the impact level “Medium” is the next greatest, and the impact level “Low” is the smallest.

Next, the processing unit 12 determines attributes of information to be acquired, based on the determined impact level. For example, the processing unit 12 determines that, as the impact level is greater, more attributes are included as the attributes of information to be acquired. Alternatively, the processing unit 12 may determine the attributes of information to be acquired, according to a combination of type information and impact level. For example, in the information processing program executed by the processing unit 12, one or more attributes of information to be acquired are set in association with each possible combination of type information and an impact level. The correspondence between each combination of type information and an impact level, and the attributes of information to be acquired may be managed using, for example, a data table. The processing unit 12 determines that the information attributes indicated by an information group set in association with the combination of the type information indicated in the message 2 and the determined impact level are the attributes of information to be acquired.

Then, the processing unit 12 acquires collection target information (second information) having the determined attributes from trouble job information (first information) relating to the job in which the trouble has occurred. For example, the processing unit 12 extracts the trouble job information relating to the job that has caused the occurrence of the message 2, from the job-related information 3. Then, the processing unit 12 acquires the collection target information having the determined attributes, from the extracted trouble job information.

The processing unit 12 outputs, based on the collected information, trouble information 5 to be used for the investigation of the trouble that has occurred. For example, the processing unit 12 stores the trouble information 5 in the storage unit 11. Further, the processing unit 12 transmits the trouble information 5 to a device used by a user who investigates or handles the trouble that has occurred.

In the manner described above, appropriate information according to the type of the trouble that has occurred is acquired. As a result, it becomes possible to efficiently investigate the trouble that has occurred, by referring to the trouble information 5 including the acquired information. That is, since information useful for trouble investigation and handling has already been acquired, the effort of performing information search and others in order to conduct the investigation is eliminated. Further, since information useful for the investigation has already been selected, the amount of information to be confirmed by the user is reduced, and the time needed for the investigation is shortened.

The processing unit 12 may acquire information on a handling method corresponding to the type information, from the handling method information 4 indicating handling methods for a plurality of possible troubles. By acquiring the information on a handling method, it becomes possible to efficiently handle the trouble, based on the trouble information 5 including that information.

The processing unit 12 is also able to analyze a factor that has caused the trouble, based on the acquired collection target information. For example, the processing unit 12 identifies, based on the type of the trouble, candidate factors of the trouble, which are assumed for the trouble type. The processing unit 12 then determines, for each identified candidate factor, whether the acquired collection target information satisfies the conditions for establishing that candidate factor. Then, the processing unit 12 includes, as an analysis result, a candidate factor whose establishment conditions are satisfied, in the trouble information 5. By doing so, the time needed to investigate the factor that has caused the trouble is shortened.

In this connection, the processing unit 12 may be configured to analyze a factor that has caused a trouble,

only in the case where the impact level of the trouble is a predetermined value (for example, “High”). For example, this approach eliminates the need to analyze factors that cause troubles with a low impact level, which reduces the load on the information processing apparatus 10.

### Second Embodiment

A second embodiment relates to a computer system capable of shortening the investigation time for crucial troubles.

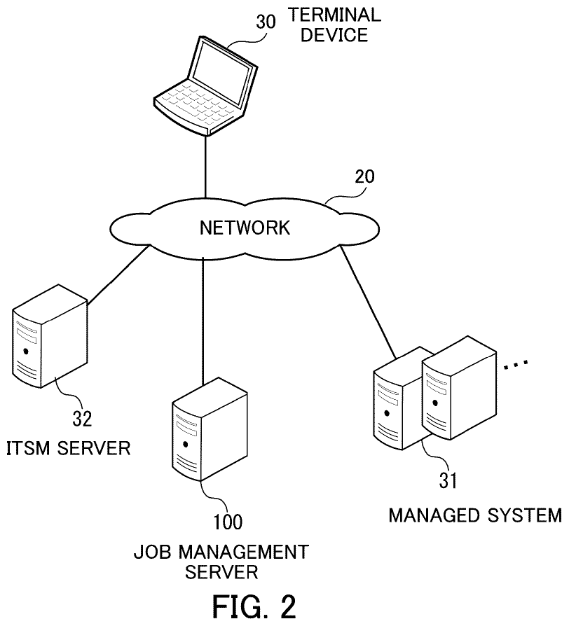

FIG. 2 illustrates an example of a system configuration according to the second embodiment. A managed system 31 and a job management server 100 are connected to each other via a network 20. The managed system 31 is a computer system that provides services by executing jobs. The managed system 31 is, for example, a composite system that includes on-premise computers, and computers in cloud systems such as infrastructure as a service (IaaS), platform as a service (PaaS), and software as a service (SaaS).

The job management server 100 is a computer that manages jobs in the managed system 31.

A terminal device 30 and an information technology service management (ITSM) server 32 are further connected to the network 20. The terminal device 30 is a computer that is used by a user who analyzes troubles in the managed system 31. The ITSM server 32 is a computer that provides operation management services for computer systems.

The job management server 100 manages the states of jobs executed in the managed system 31 and the execution history of the jobs. The job management server 100 monitors the execution states of the jobs and outputs, if any abnormality occurs, a trouble message. Then, the job management server 100 collects information according to the trouble that has occurred. The job management server 100 is also able to automatically analyze the cause of the trouble, based on the information collected according to the trouble.

The job management server 100 transmits incident information that includes information collected according to the trouble that has occurred, to the ITSM server 32. The ITSM server 32 provides the incident information in response to a request from the terminal device 30.

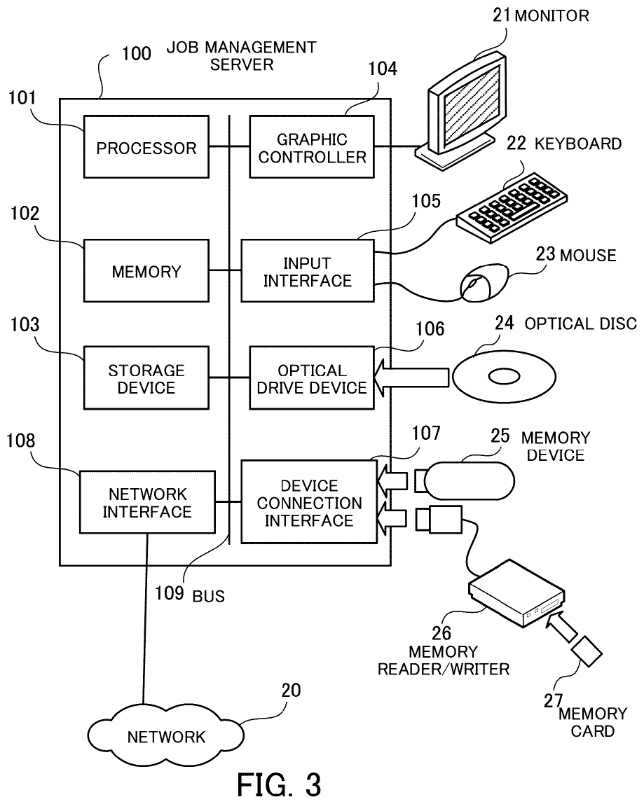

FIG. 3 illustrates an example of the hardware of the job management server. The job management server 100 is entirely controlled by a processor 101. A memory 102 and a plurality of peripheral devices are connected to the processor 101 via a bus 109.

The job management server 100 may be a multiprocessor system with a plurality of processors. A set of processors in the multiprocessor system may be referred to as the processor 101. The processor 101 may also be referred to as processor circuitry. Each of the processors may perform some or all of a plurality of processes executed by the job management server 100. Among a plurality of related processes, two or more processes may be performed by different processors.

The processor 101 may be, for example, a central processing unit (CPU), a micro processing unit (MPU), or a digital signal processor (DSP).

The memory 102 is used as a main storage device of the job management server 100. The memory 102 temporarily stores at least a part of an operating system (OS) program and an application program to be executed by the processor 101. The memory 102 also stores various data to be used by the processor 101 during its operation. A volatile semiconductor storage device such as random access memory (RAM) is used as the memory 102.

The peripheral devices connected to the bus 109 include a storage device 103, a graphic controller 104, an input interface 105, an optical drive device 106, a device connection interface 107, and a network interface 108. 114 The storage device 103 electrically or magnetically writes and reads data to and from a built-in recording medium. The storage device 103 is used as an auxiliary storage device of the job management server 100. The storage device 103 stores an OS program, an application program, and various data. The storage device 103 may be, for example, a hard disk drive (HDD) or a solid state drive (SSD).

The graphic controller 104 is an arithmetic device that performs image processing. The graphic controller 104 is, for example, a graphics processing unit (GPU). A monitor 21 is connected to the graphic controller 104. The graphic controller 104 displays images on the screen of the monitor 21 in accordance with instructions from the processor 101. The monitor 21 is a display device using an organic electro luminescence (EL) or a liquid crystal display device.

A keyboard 22 and a mouse 23 are connected to the input interface 105. The input interface 105 transmits signals received from the keyboard 22 and the mouse 23 to the processor 101. The mouse 23 is an example of a pointing device.

The optical drive device 106 reads data from an optical disc 24 or writes data to the optical disc 24 by using a laser beam or the like. The optical disc 24 is a portable recording medium on which data is recorded so as to be readable by reflection of light.

The device connection interface 107 is a communication interface for connecting peripheral devices to the job management server 100. For example, a memory device 25 or a memory reader/writer 26 may be connected to the device connection interface 107. The memory device 25 is a recording medium having a function of communication with the device connection interface 107. The memory reader/writer 26 is a device that writes data to a memory card 27 or reads data from the memory card 27. The memory card 27 is a card type recording medium.

The network interface 108 is connected to the network 20. The network interface 108 transmits and receives data to and from other computers and communication devices via the network 20. The network interface 108 is, for example, a wired communication interface. The network interface 108 may be a wireless communication interface.

With the hardware described above, the job management server 100 is able to implement the processing functions of the second embodiment. The information processing apparatus 10 of the first embodiment may also be implemented with the same hardware as the job management server 100 illustrated in FIG. 3.

The job management server 100 implements the processing functions of the second embodiment, for example, by executing a program recorded on a computer-readable recording medium. The program describing the content of the processing to be performed by the job management server 100 may be recorded on various recording media. For example, a program to be executed by the job management server 100 may be stored in the storage device 103. The program to be executed by the job management server 100 may also be recorded on a portable recording medium such as the optical disc 24, the memory device 25, or the memory card 27.

With the above system, incident information corresponding to troubles that have occurred is registered. The incident information includes information useful for investigating the causes of the troubles that have occurred. The following describes the difficulty in appropriately determining information to be included in the incident information.

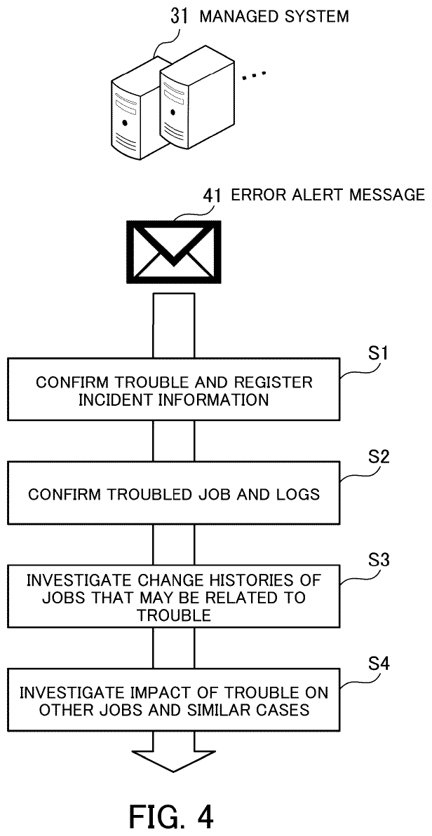

FIG. 4 illustrates an example procedure for trouble handling when a trouble occurs. For example, when a trouble related to the execution of a job occurs in the managed system 31, an error alert message 41 is output from the managed system 31. In the example of FIG. 4, first, on the basis of the error alert message 41, the trouble is confirmed and incident information is registered (step S1). Next, the troubled job and logs are confirmed (step S2). Furthermore, change histories of jobs that may be related to the trouble are investigated (step S3). Then, the impact of the trouble on other jobs, and similar cases are investigated (step S4).

In the case of performing trouble handling in accordance with the above procedure, the investigation of a trouble may be made efficient if the registration of incident information, which is performed first, is automated. In the automation of the registration of incident information, it is important that information to be used for trouble handling is included in the incident information without excess or deficiency.

Job troubles may be classified into a plurality of categories (trouble types) such as Abnormal End and Start Delay. The perspective of a trouble investigation differs for each trouble type. Therefore, the attributes of information to be used for trouble investigation also differ for each trouble type. Conventionally, experts need to additionally investigate each environment to collect information useful for the investigation and handling method consideration, which results in a delay in registering incident information.

Note that, in conventional systems that automatically collect logs related to troubles, information is not collected while taking into account trouble types. This means that appropriate information is not collected, and the collected information is insufficient from the point of view of job trouble investigation. To address this, the job management server 100 performs the following processing in order to issue an incident including appropriate information according to a trouble that has occurred.

When receiving an error alert message regarding a job in which a trouble has occurred, the job management server 100 dynamically determines a range of information to be acquired, according to the impact level of the trouble on the overall system, which is determined based on the trouble type of the trouble. The job management server 100 collects information according to the determined information range, and determines optimal investigation materials and a handling method while taking into account the trouble type of the job. Then, the job management server 100 registers incident information including the collected information and information indicating the handling method in the ITSM server 32. With this approach, the investigation time for crucial troubles is shortened. Furthermore, since judgment by experts are not involved, the investigation may be achieved with less-skilled users.

Next, the functions of the job management server 100 for generating appropriate incident information according to trouble type will be described.

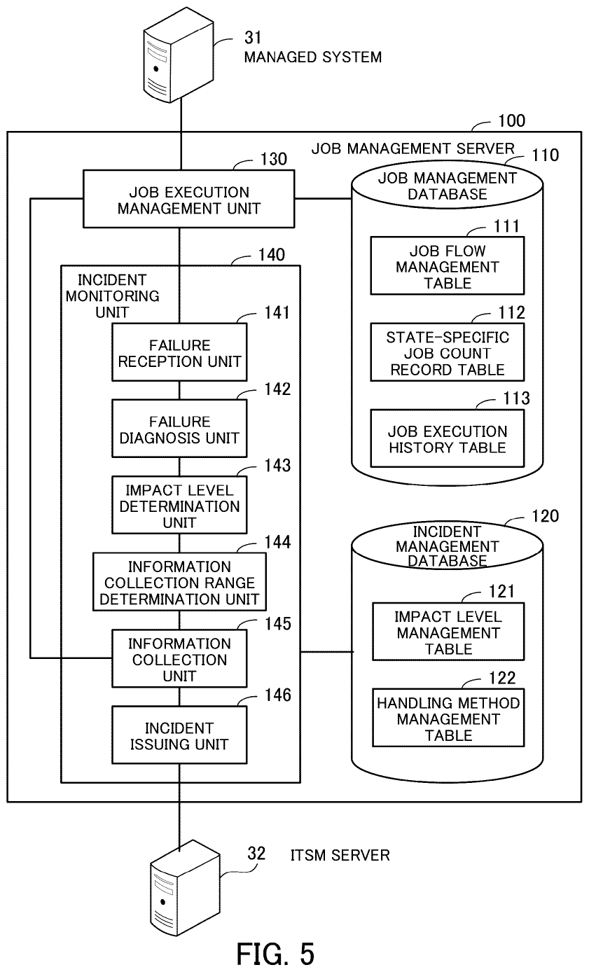

FIG. 5 is a block diagram illustrating an example of the functions of the job management server. The job management server 100 includes a job management database 110, an incident management database 120, a job execution management unit 130, and an incident monitoring unit 140.

The job management database 110 is a database that records information on jobs that are executed in the managed system 31. The job management database 110 includes a job flow management table 111, a state-specific job count record table 112, and a job execution history table 113.

The job flow management table 111 is a data table that holds a job flow for implementing a service to be provided. The job flow indicates the execution order of jobs.

The state-specific job count record table 112 is a data table that records, for each unit time zone with a predetermined time width, the number of jobs in a predetermined state during that unit time zone. For example, the state-specific job count record table 112 indicates the multiplicity of jobs (the number of jobs being executed concurrently).

The job execution history table 113 is a data table that records the execution histories of individual jobs. For example, the job execution history table 113 contains, for each executed job, a timestamp indicating the execution start time.

The incident management database 120 is a database that records information to be used for issuing incidents corresponding to job troubles. The incident management database 120 includes an impact level management table 121 and a handling method management table 122.

The impact level management table 121 is a data table that records information to be used for determining the impact level of a trouble when the trouble occurs in a job. For example, the impact level management table 121 contains an impact level for each kind of jobs and for each kind of troubles (trouble type).

The handling method management table 122 is a data table that records information to be used for determining a handling method for a trouble when the trouble occurs in a job. For example, the handling method management table 122 contains handling methods corresponding to trouble details, for each trouble type.

The job execution management unit 130 manages the execution states of jobs executed in the managed system 31. For example, the job execution management unit 130 monitors the managed system 31 to monitor, for example, the registration of jobs waiting for execution in a job queue, the start and end of execution of each job, and others. The job execution management unit 130 registers information obtained through the job monitoring, in the job management database 110.

When receiving an error alert message indicating a trouble related to job execution from the managed system 31, the job execution management unit 130 transfers the error alert message to the incident monitoring unit 140. When receiving, from the incident monitoring unit 140, a request for acquiring information from the job management database 110, the job execution management unit 130 retrieves the requested information from the job management database 110 and returns the information to the incident monitoring unit 140.

The incident monitoring unit 140 manages information relating to incidents such as troubles occurring during job execution. For example, when receiving an error alert message from the job execution management unit 130, the incident monitoring unit 140 generates incident information according to the content of the error alert message. Then, the incident monitoring unit 140 transmits the generated incident information to the ITSM server 32. The incident monitoring unit 140 includes a failure reception unit 141, a failure diagnosis unit 142, an impact level determination unit 143, an information collection range determination unit 144, an information collection unit 145, and an incident issuing unit 146, in order to manage information relating to incidents.

The failure reception unit 141 receives an error alert message transmitted from the job execution management unit 130. The failure reception unit 141 generates a template of trouble information corresponding to the received error alert message. The failure reception unit 141 transmits the error alert message to the failure diagnosis unit 142.

The failure diagnosis unit 142 analyzes the content of the error alert message and determines the trouble type of the trouble that has occurred. The failure diagnosis unit 142 sets the determined trouble type in trouble information.

The impact level determination unit 143 determines the impact level of the trouble that has occurred. The impact level of trouble is evaluated in three levels: “Low”, “Medium”, and “High”, for example. The impact level determination unit 143 transmits the error alert message having added thereto information indicating the impact level, to the information collection range determination unit 144.

The information collection range determination unit 144 determines the range of information (information collection range) useful for determining a handling method for the trouble that has occurred. The attributes of information to be collected are set as the information collection range. For example, the information collection range determination unit 144 determines the information collection range indicating the range of information to be collected, according to the trouble type and the impact level. The information collection range determination unit 144 notifies the information collection unit 145 of the determined information collection range.

The information collection unit 145 collects information according to the trouble that has occurred. In the case where information to be collected is present in the job management database 110, the information collection unit 145 acquires the information via the job execution management unit 130. The information collection unit 145 may also determine a handling method for the trouble that has occurred. The information collection unit 145 transmits trouble information including the collected information to the incident issuing unit 146. In the case where a handling method for the trouble is determined, the trouble information also includes the trouble handling method.

The incident issuing unit 146 transmits incident information including the received trouble information to the ITSM server 32. The ITSM server 32 manages the incident information for each trouble that has occurred. A user is able to access the ITSM server 32 using the terminal device 30, to confirm the incident information.

The function of each element illustrated in FIG. 5 is implemented, for example, by causing the processor 101 to execute a program module corresponding to that element. Every time a trouble occurs in a job, the job management server 100 having the above functions collects information useful for handling the trouble and issues an incident including the information.

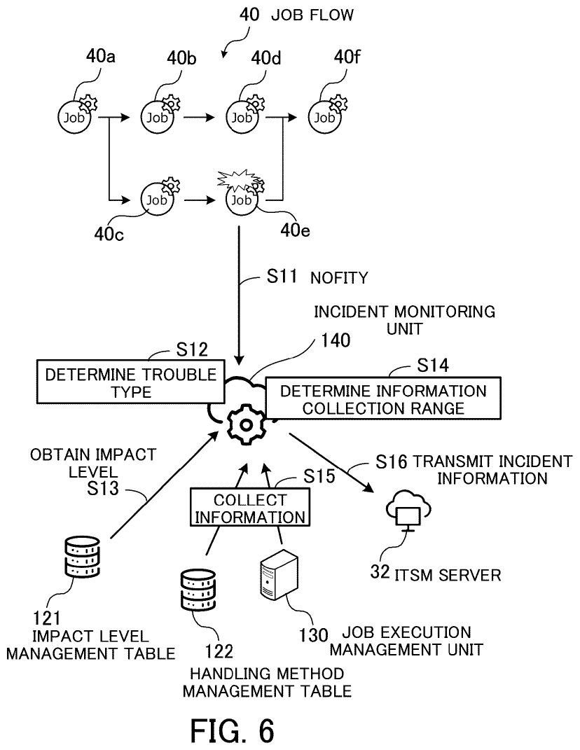

FIG. 6 illustrates an example of a process flow from occurrence of a trouble to issuance of an incident. For example, it is assumed that a service based on a job flow 40 is provided by the managed system 31. The managed system 31 first executes a job 40a in accordance with the job flow 40. After the execution of the job 40a is completed, the managed system 31 executes two jobs 40b and 40c. The managed system 31 executes a job 40d after the execution of the job 40b is completed, and executes a job 40e after the execution of the job 40c is completed. Then, the managed system 31 executes a job 40f after the execution of the jobs 40d and 40e is completed.

Here, it is assumed that a trouble occurs during the execution of the job 40e while the managed system 31 is providing a service in accordance with the job flow 40. The managed system 31 transmits an error alert message to notify the job management server 100 of information on the trouble (step S11). In the job management server 100, the incident monitoring unit 140 determines a trouble type based on the content of the error alert message (step S12). Further, the incident monitoring unit 140 obtains an impact level corresponding to the details of the trouble indicated in the error alert message, with reference to the impact level management table 121 (step S13). The incident monitoring unit 140 determines an information collection range according to the trouble type and the impact level (step S14). The incident monitoring unit 140 collects information specified by the information collection range, from the job execution management unit 130, the handling method management table 122, and others (step S15). The incident monitoring unit 140 then organizes the collected information and transmits incident information including the organized information to the ITSM server 32 (step S16).

The range of information to be collected depends on the impact level. For example, in the case where the impact level of a trouble is “Low”, the information collection range includes 4W1H information (error alert message and handling method) for solving the trouble. This information is useful for trouble investigation and primary handling consideration.

In the case where the impact level of a trouble is “Medium”, the information collection range includes information on a subsequent job to be affected, in addition to the information to be collected for the impact level “Low”. This information is useful for confirming the operation impact of the trouble.

In the case where the impact level of a trouble is “High”, the information collection range includes detailed information of investigation perspective, which differs depending on the trouble type of a job, and an analysis result, in addition to the information to be collected for the impact level “Medium”. This information is useful for early resolution of the trouble.

For example, there are five trouble types: “Abnormal End”, “Start Delay”, “End Delay”, “Execution Skip”, and “Execution Rejection”. In the case where the impact level is “High”, optimal investigation materials are collected according to a trouble type. In addition, in the case where the impact level is “High”, information on an appropriate handling method is also collected for at least one of the trouble types.

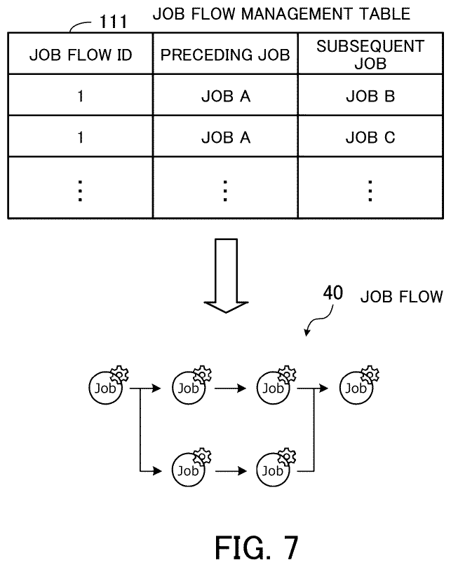

The following specifically describes data used for appropriate information collection, with reference to FIGS. 7 to 11.

FIG. 7 illustrates an example of the job flow management table. For example, the job flow management table 111 contains each pair of jobs having a precedence relationship within a job flow, in association with a job flow ID. For example, the job name of a job to be executed first is set as a preceding job. The job name of a job that starts execution after the corresponding preceding job is completed is set as a subsequent job. It is possible to confirm, with reference to the job flow management table 111, the precedence relationship of jobs in the job flow 40 for implementing a predetermined service.

Note that a job may refer to a group of a plurality of jobs. Such a group of one or more jobs is called a job net. Therefore, a job name, which uniquely identifies a job, is sometimes referred to as a job net name to refer to a collection of one or more jobs that implements the job.

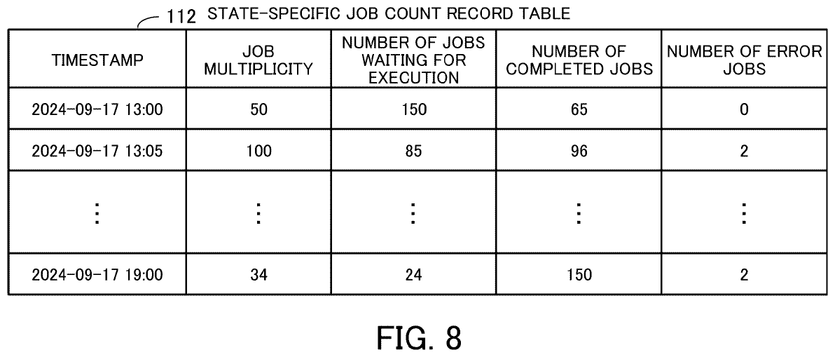

FIG. 8 illustrates an example of the state-specific job count record table. The state-specific job count record table 112 contains job multiplicity, the number of jobs waiting for execution, the number of completed jobs, and the number of error jobs in association with a timestamp indicating a unit time zone. The timestamp indicates the start time of the corresponding unit time zone. The job multiplicity is the number of jobs executed in parallel within the unit time zone. The number of jobs waiting for execution is the number of jobs kept waiting for execution in the unit time zone. The number of completed jobs is the number of jobs whose execution completed within the unit time zone. The number of error jobs is the number of jobs that ended in error within the unit time zone.

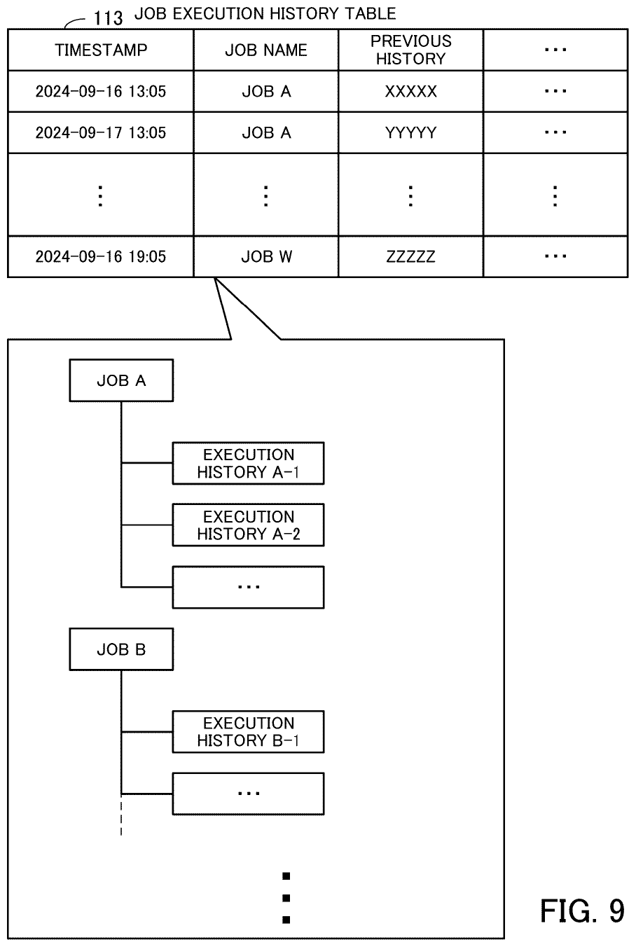

FIG. 9 illustrates an example of the job execution history table. The job execution history table 113 contains, for the execution history of each job, a job name, a previous history, and others in association with a timestamp indicating the start time of that job. The previous history is a pointer to a record indicating an execution history regarding the last execution of the job having the same name. For example, by grouping the records in the job execution history table 113 by job name, the chronological execution history of each job is obtained.

Each record of the job execution history table 113 may also include a scheduled start time, a scheduled end time, an actual end time upon execution, a start condition, and others.

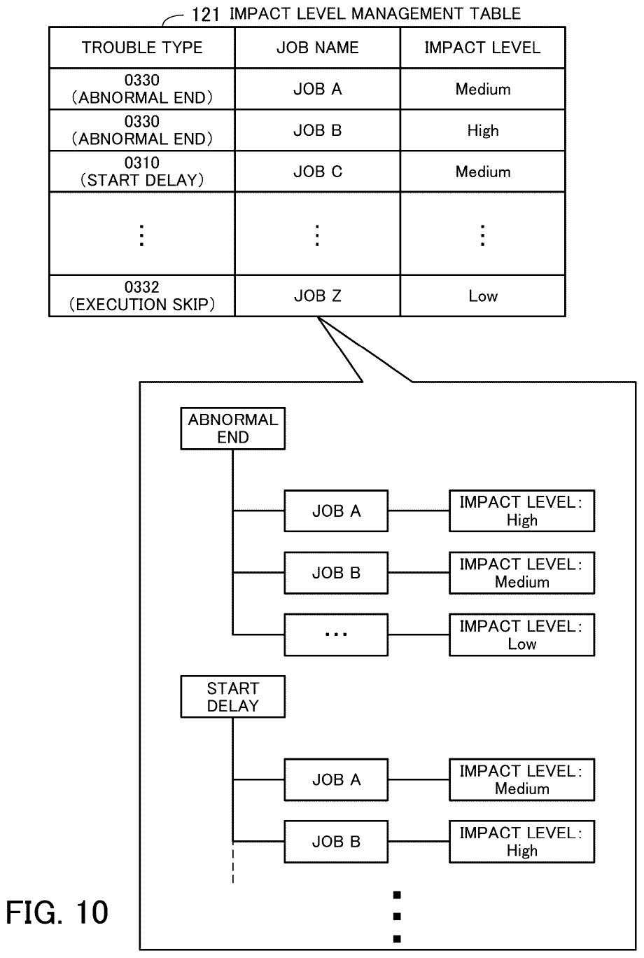

FIG. 10 illustrates an example of the impact level management table. The impact level management table 121 contains, in association with each combination of a trouble type and a job name, an impact level corresponding to the job having that job name and that trouble type. For example, by grouping the records in the impact level management table 121 by trouble type, the impact level of each job in each trouble type is obtained.

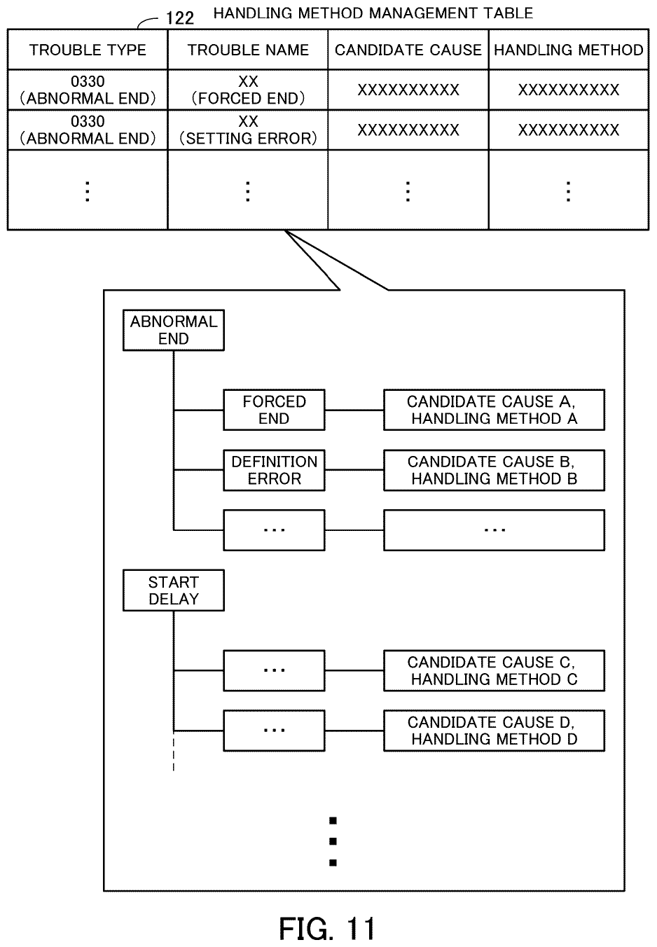

FIG. 11 illustrates an example of the handling method management table. The handling method management table 122 contains a candidate cause and a handling method in association with each combination of a trouble type and a trouble name. The trouble name is information indicating the details of a trouble corresponding to the trouble type. When a trouble occurs, the trouble name of the trouble may be obtained by analyzing information included in an error alert message. The candidate cause is information indicating an event that is a possible cause of the trouble. The handling method is information indicating a way to handle the trouble. It is possible to obtain, with reference to the handling method management table 122, a candidate cause and a handling method corresponding to the trouble type of a trouble, when it occurs.

Using the above data, incident information relating to a trouble, when it occurs in a job, is generated. When receiving an error alert message, the incident monitoring unit 140 first identifies a trouble type.

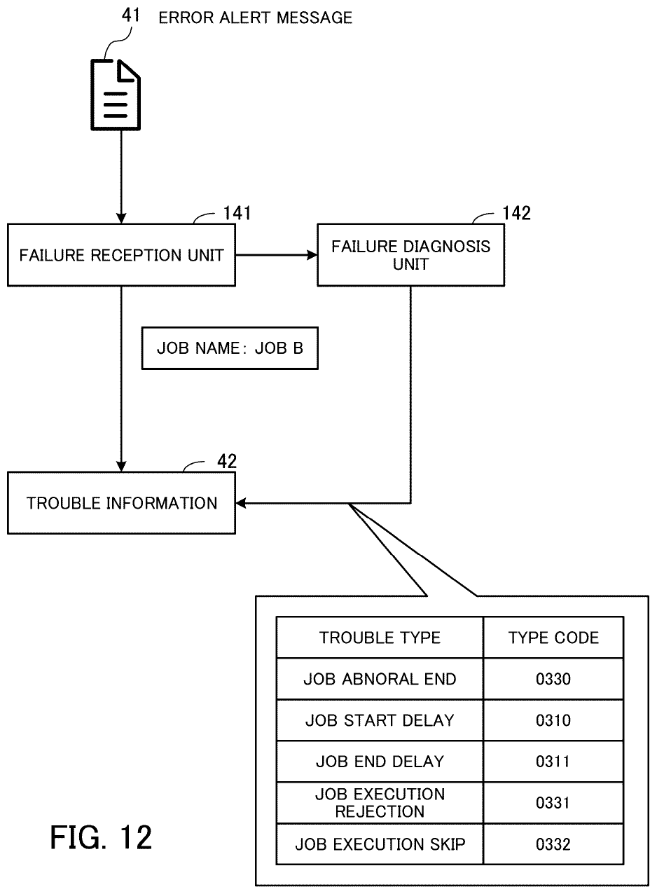

FIG. 12 illustrates an example procedure for a trouble type identification process. When an error alert message 41 is input to the incident monitoring unit 140 via the job execution management unit 130, the failure reception unit 141 receives the error alert message 41. The failure reception unit 141 generates, based on a prepared template, trouble information 42 in the predetermined data format. For example, the job name of the job in which the trouble has occurred is set in the trouble information 42. Then, the failure reception unit 141 transmits the error alert message 41 to the failure diagnosis unit 142.

The failure diagnosis unit 142 extracts a type code indicating a trouble type from the error alert message 41. The type code is an example of the type information described in the first embodiment. Trouble types are set to cover general troubles that occur during job execution. If troubles are of different trouble types, the causes of the troubles and the handling methods therefor may differ. For example, if a trouble type is Start Delay, the cause may be a dependency relationship between jobs. If a trouble type is End Delay, the cause may be an increase in the amount of data processed in the job. Therefore, identifying the trouble type of a trouble improves the accuracy of determining the cause of the trouble.

For example, a type code “0330” is set to indicate that a trouble is an abnormal end of a job. A type code “0310” is set to indicate that a trouble is a start delay of a job. A type code “0311” is set to indicate that a trouble is an end delay of a job. A type code “0331” is set to indicate that a trouble is an execution rejection of a job. A type code “0332” is set to indicate that a trouble is an execution skip of a job. The failure diagnosis unit 142 sets the extracted type code in the trouble information 42.

After the trouble type is identified, the impact level determination unit 143 determines the impact level of the trouble, which has occurred, on the overall system.

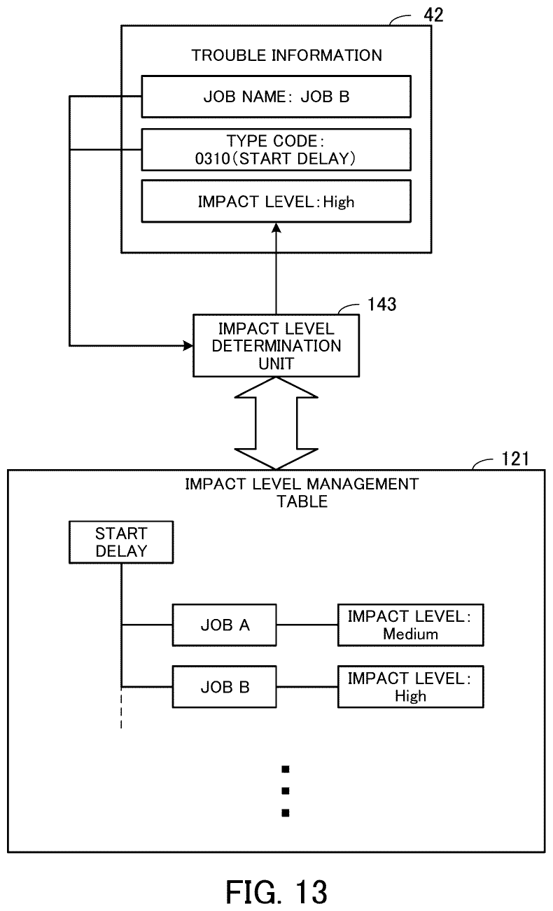

FIG. 13 illustrates an example of an impact level determination process; The impact level determination unit 143 acquires a job name and the type code of a trouble type from the trouble information 42. The impact level determination unit 143 confirms the trouble type based on the type code. Then, the impact level determination unit 143 determines the impact level corresponding to the combination of the job name and the trouble type with reference to the impact level management table 121. In the example of FIG. 13, the job name is “job B” and the trouble type is “Start Delay” (type code “0310”). According to the impact level management table 121, the impact level of the Start Delay trouble in the job B is “High”. Therefore, the impact level determination unit 143 sets the impact level “High” in the trouble information 42.

When the impact level is determined, the information collection range determination unit 144 determines an information collection range based on the determined impact level.

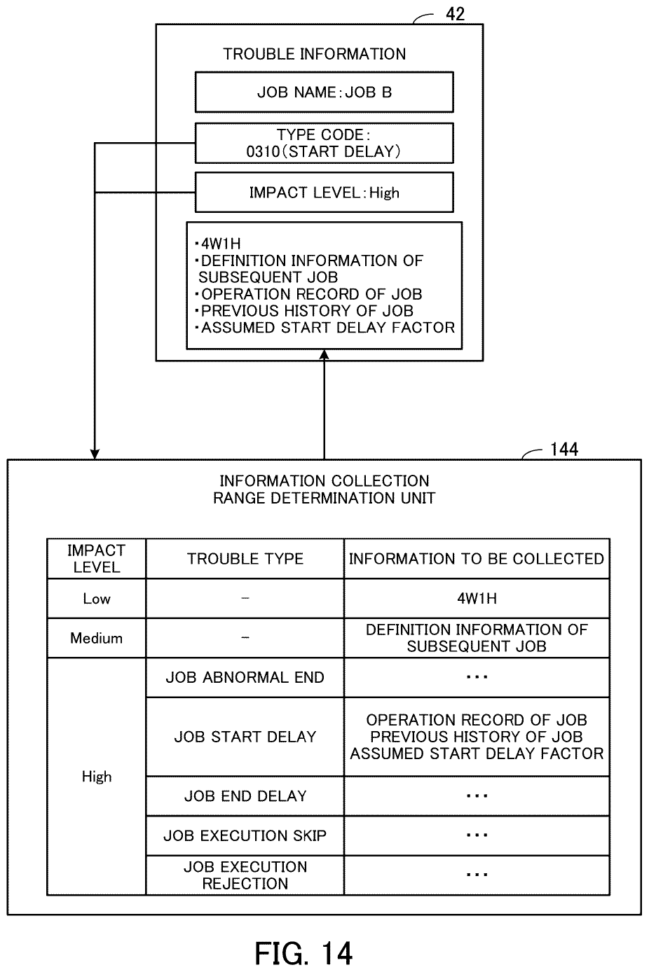

FIG. 14 illustrates an example of an information collection range determination process. The information collection range determination unit 144 obtains the type code and the impact level from the trouble information 42. For example, if the impact level is “Low”, the information collection range determination unit 144 includes 4W1H information in the information collection range. If the impact level is “Medium”, the information collection range determination unit 144 includes definition information of a subsequent job, as well as the 4W1H information, in the information collection range. If the impact level is “High”, the information collection range determination unit 144 includes information to be collected according to the trouble type indicated by the type code, as well as the 4W1H information and the definition information of a subsequent job, in the information collection range. For example, if the trouble type is a start delay of a job, the information collection range determination unit 144 includes the operation record of the job, the previous history of the job, an assumed start delay factor, and others in the information collection range.

The information collection range determination unit 144 sets the information collection range according to the combination of the impact level and the trouble type, in the trouble information 42. When the information collection range is determined, the information collection unit 145 collects information specified by the information collection range.

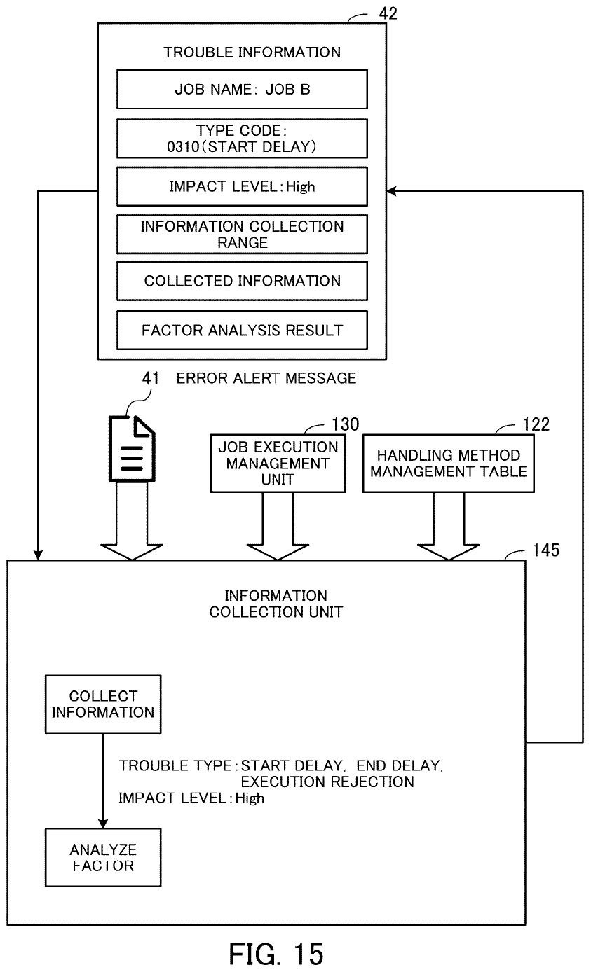

FIG. 15 illustrates an example of an information collection process. The information collection unit 145 obtains information indicating an information collection range from the trouble information 42. The information collection unit 145 then collects information specified by the information collection range from the error alert message 41, the job execution management unit 130, the handling method management table 122, and others.

In the case where a predetermined condition is satisfied, the information collection unit 145 performs factor analysis. For example, in the case where a trouble type is Start Delay, End Delay, or Execution Rejection and the impact level is “High”, the information collection unit 145 performs the factor analysis. The information collection unit 145 sets the collected information in the trouble information 42. After the factor analysis, the information collection unit 145 sets the result of the factor analysis in the trouble information 42.

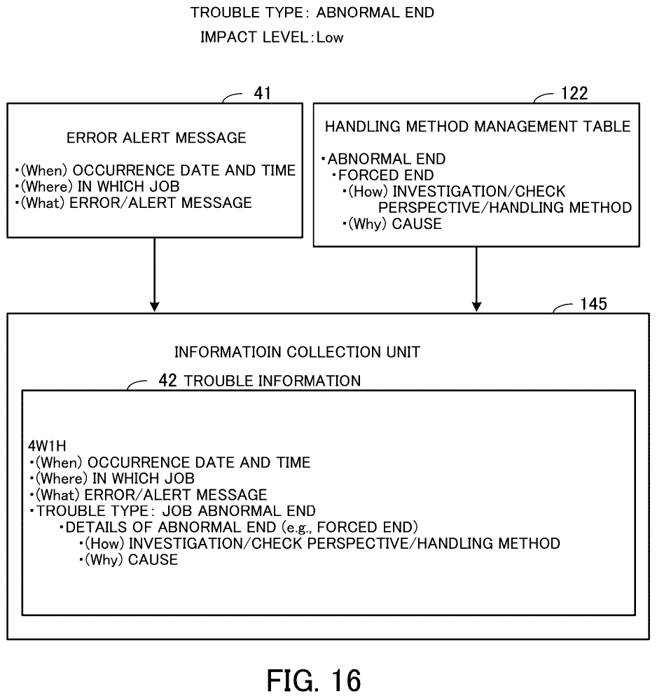

FIG. 16 illustrates an example of information collection for a trouble having the trouble type of “Abnormal End” and the impact level of “Low”. In the case where a trouble type is Abnormal End and an impact level is “Low”, 4W1H information is collected. Among the 4W1H information, the occurrence date and time (When), the job in which the trouble has occurred (Where), and the content of the error/alert message (What) are obtained from the error alert message 41. Further, investigation/check perspective/handling method (How) and the cause (Why) are obtained from the handling method management table 122. Regarding the investigation/check perspective/handling method (How) and cause (Why), for example, information is obtained according to a trouble name (such as Forced End or Setting Error) of Abnormal End.

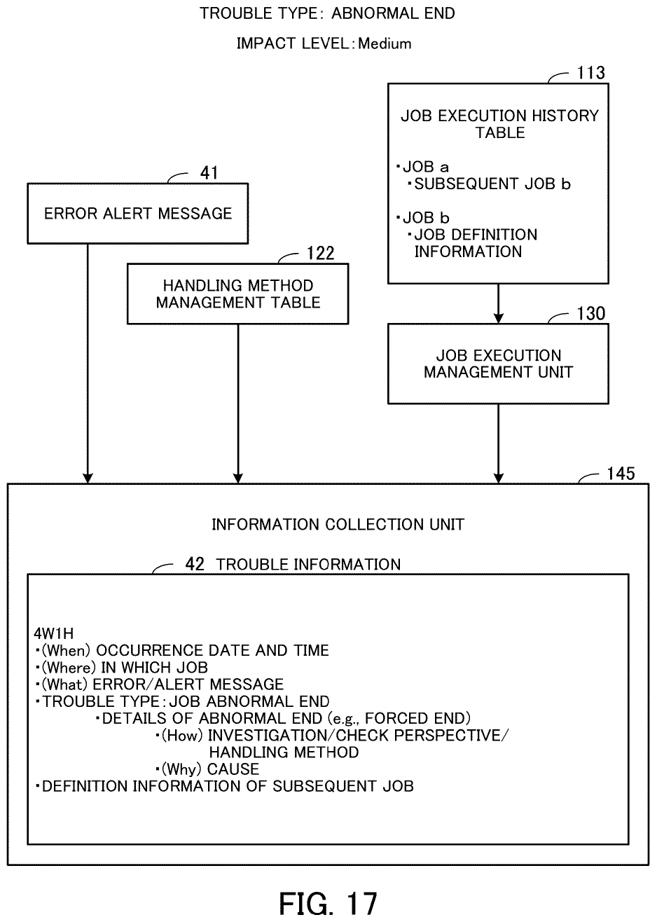

FIG. 17 illustrates an example of information collection for a trouble having the trouble type of “Abnormal End” and the impact level of “Medium”. In the case where a trouble type is Abnormal End and an impact level is “Medium”, 4W1H information and the definition information of a subsequent job are collected. The definition information of a subsequent job is obtained from the job execution history table 113 via the job execution management unit 130. That is, a subsequent job to be affected by the trouble that has occurred is identified, and the definition information on the job is acquired.

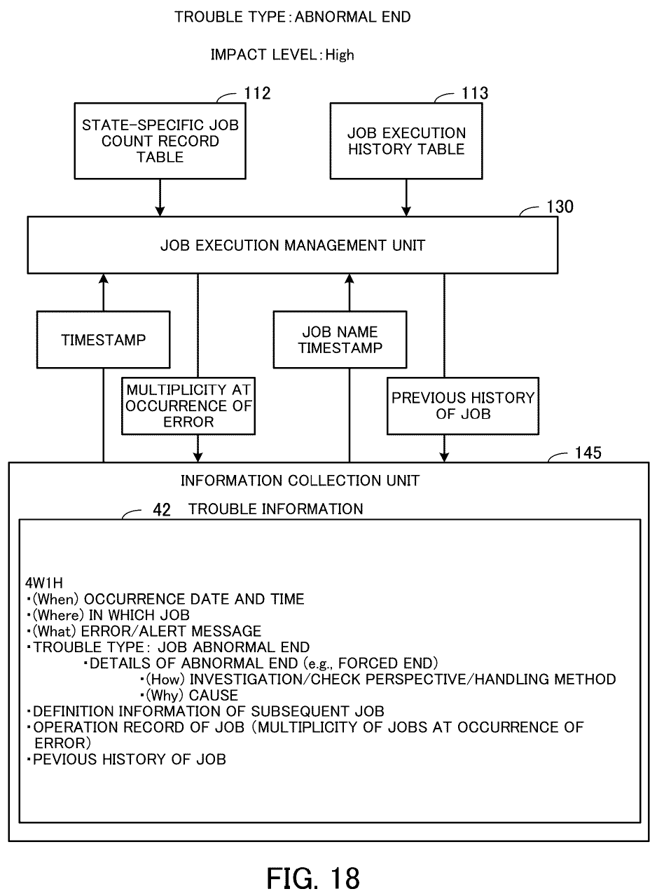

FIG. 18 illustrates an example of information collection for a trouble having the trouble type of “Abnormal End” and the impact level of “High”. In the case where a trouble type is Abnormal End and an impact level is “High”, for example, 4W1H information, the definition information of a subsequent job, the operation record of the job, and the previous history of the job are collected.

As the operation record of the job, for example, the multiplicity at the time of error occurrence is obtained. To obtain the multiplicity at the time of error occurrence, the information collection unit 145 transmits a multiplicity information acquisition request including a timestamp indicating the error occurrence time, to the job execution management unit 130. The job execution management unit 130 obtains the multiplicity of jobs in a unit time zone including the time indicated by the timestamp, with reference to the state-specific job count record table 112. The job execution management unit 130 transmits the obtained multiplicity as the multiplicity at the time of error occurrence, to the information collection unit 145.

To obtain the previous history of the job, the information collection unit 145 transmits, to the job execution management unit 130, an information acquisition request including the job name of the job that is the source of the error and the timestamp indicating the error occurrence time. The job execution management unit 130 obtains, for the job identified by the job name, the previous execution history immediately preceding the execution history identified by the timestamp, with reference to the job execution history table 113. The job execution management unit 130 transmits the obtained previous execution history of the job to the information collection unit 145.

Information to be collected for a trouble having the trouble type of Start Delay and the impact level of “Low” is the same as that for a trouble having the trouble type of Abnormal End and the impact level of “Low” (see FIG. 16). Information to be collected for a trouble having the trouble type of Start Delay and the impact level of “Medium” is the same as that for a trouble having the trouble type of Abnormal End and the impact level of “Medium” (see FIG. 17).

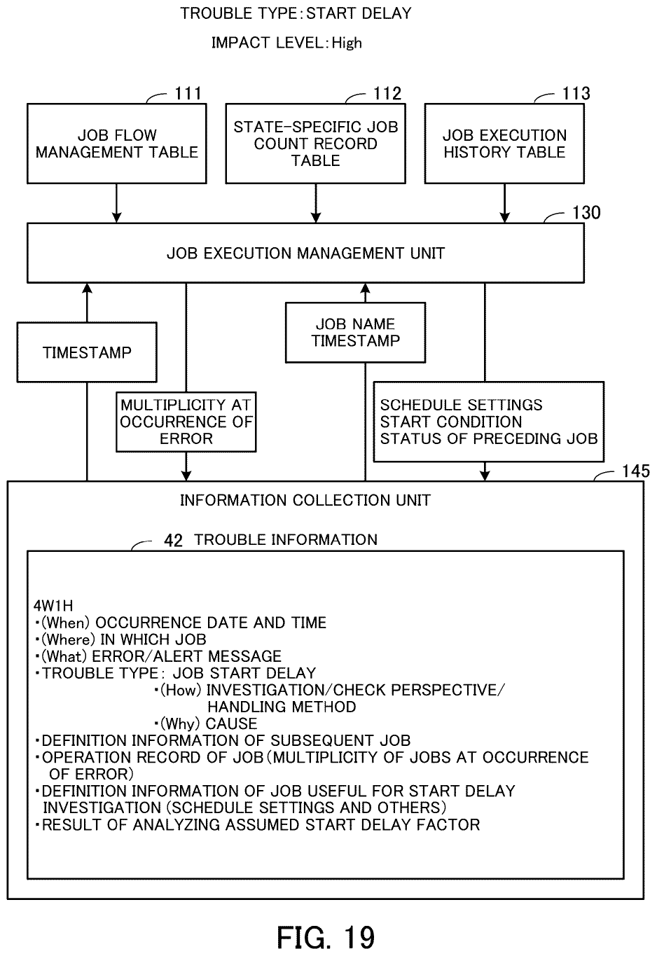

FIG. 19 illustrates an example of information collection for a trouble having the trouble type of “Start Delay” and the impact level of “High”. In the case where a trouble type is Start Delay and an impact level is “High”, for example, 4W1H information, the definition information of a subsequent job, the operation record of the job, the definition information (such as schedule settings) of the job useful for start delay investigation, information on an assumed start delay factor, and others are collected. The operation record of the job is, for example, the multiplicity of jobs at the time of error occurrence, and the multiplicity is obtained as illustrated in FIG. 18.

The definition information of the job useful for the start delay investigation is, for example, schedule settings (scheduled start time of the job), information on a start condition (the occurrence state of a prerequisite event), information on the status of a preceding job, and others. For example, the information collection unit 145 transmits an information acquisition request including the job name of the job that is the source of the error and a timestamp indicating the error occurrence time, to the job execution management unit 130. The job execution management unit 130 then returns the schedule settings of the job identified by the job name, the start condition, the status of the preceding job, and others to the information collection unit 145.

The information collection unit 145 sets the acquired information in the trouble information 42. In addition, the information collection unit 145 performs an assumed start delay factor analysis using the acquired information, and includes the analysis result in the trouble information 42.

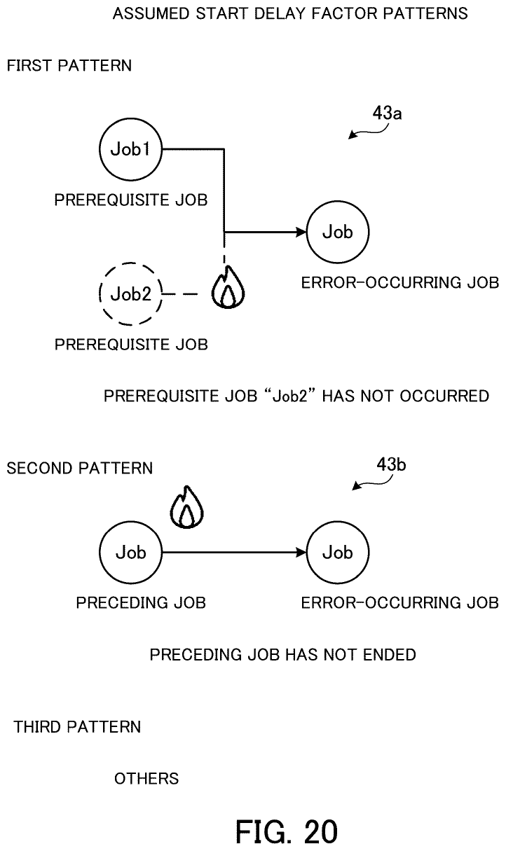

FIG. 20 illustrates an example of an assumed start delay factor analysis. Assumed factor patterns include a first pattern 43a, a second pattern 43b, and a third pattern including other patterns. The first pattern 43a includes two preceding prerequisite jobs for an error-occurring job. The error-occurring job is executed after these preceding prerequisite jobs end. The first pattern 43a is a pattern in which the error occurs because one of the prerequisite jobs has not occurred. The second pattern 43b is a pattern in which the error occurs because the preceding job of the error-occurring job has not ended.

The information collection unit 145 determines, based on the acquired information, whether the trouble in question falls under any of the assumed factor patterns. If the trouble in question falls under an assumed factor pattern, the information collection unit 145 sets the assumed start delay factor indicated in the assumed factor pattern, in the trouble information 42.

Information to be collected for a trouble having the trouble type of End Delay and the impact level of “Low” is the same as that for a trouble having the trouble type of Abnormal End and the impact level of “Low” (see FIG. 16). Information to be collected for a trouble having the trouble type of End Delay and the impact level of “Medium” is the same as that for a trouble having the trouble type of Abnormal End and the impact level of “Medium” (see FIG. 17).

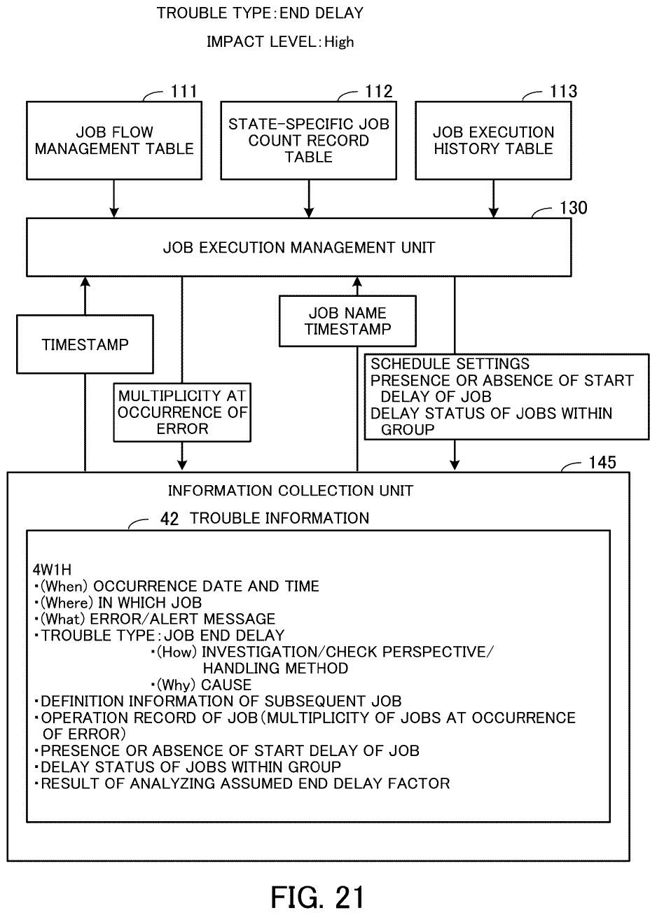

FIG. 21 illustrates an example of information collection for a trouble having the trouble type of End Delay and the impact level of “High”. In the case where a trouble type is End Delay and an impact level is “High”, for example, 4W1H information, the definition information of a subsequent job, the operation record of the job, the definition information (such as schedule settings) of the job useful for end delay investigation, information on an assumed end delay factor, and others are collected. The operation record of the job is, for example, the multiplicity of jobs at the time of error occurrence, and the multiplicity is obtained as illustrated in FIG. 18.

The definition information of the job useful for the end delay investigation is, for example, schedule settings (scheduled end time and actual end time of the job). Information on an assumed end delay factor is, for example, the presence or absence of a start delay of the job, and if the job is a group of jobs, a delay status within the group.

For example, the information collection unit 145 transmits an information acquisition request including the job name of the job that is the source of the error and a timestamp indicating the error occurrence time, to the job execution management unit 130. The job execution management unit 130 then returns the schedule settings of the job identified by the job name, the presence or absence of a start delay of the job, the delay status of jobs within the group, and others, to the information collection unit 145.

The information collection unit 145 sets the acquired information in the trouble information 42. The information collection unit 145 also performs an assumed end delay factor analysis on the basis of the acquired information, and includes the analysis result in the trouble information 42.

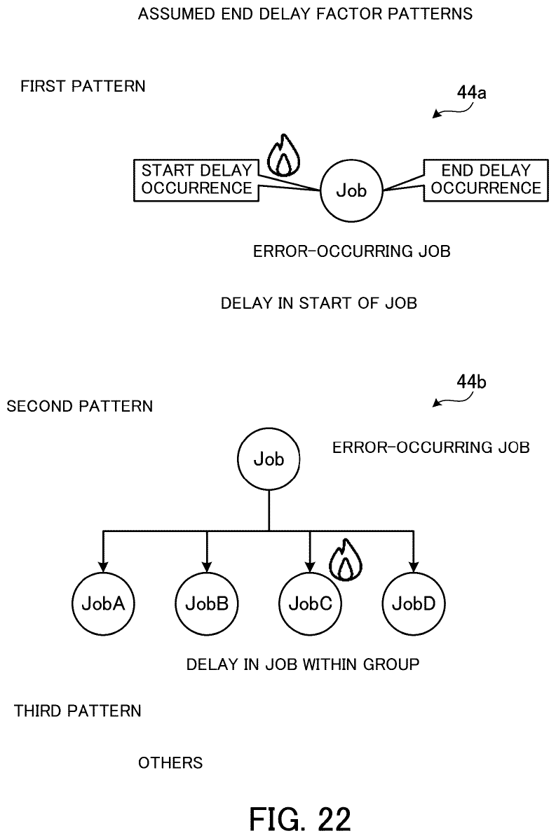

FIG. 22 illustrates an example of an assumed end delay factor analysis. Assumed factor patterns include a first pattern 44a, a second pattern 44b, and a third pattern including other patterns. The first pattern 44a is a pattern in which the error occurs because the end delay occurs due to a delay in the start of execution of the error-occurring job. The second pattern 43b is a pattern in which the error occurs because the error-occurring job is a group of a plurality of jobs and the end delay occurs in one or more jobs within the group.

The information collection unit 145 determines, based on the basis of the acquired information, whether the trouble in question falls under any of the assumed factor patterns. If the trouble in question falls under an assumed factor pattern, the information collection unit 145 sets the assumed end delay factor indicated by the assumed factor pattern, in the trouble information 42.

Information to be collected for a trouble having the trouble type of Execution Rejection and the impact level of “Low” is the same as that for a trouble having the trouble type of Abnormal End and the impact level of “Low” (see FIG. 16). Information to be collected for a trouble having the trouble type of Execution Rejection and the impact level of “Medium” is the same as that for a trouble having the trouble type of Abnormal End and the impact level of “Medium” (see FIG. 17).

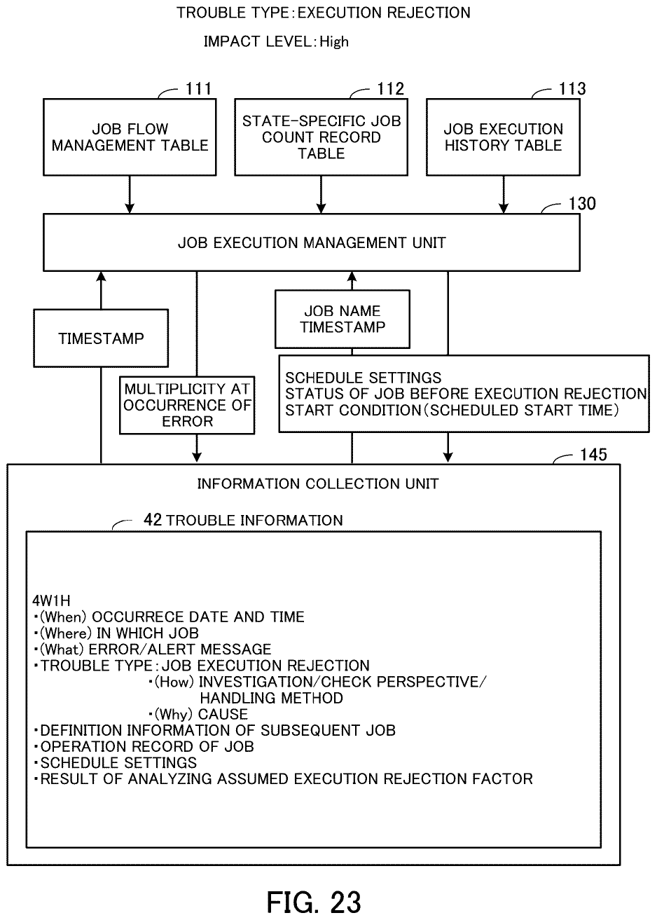

FIG. 23 illustrates an example of information collection for a trouble having the trouble type of “Execution Rejection” and the impact level of “High”. In the case where a trouble type is Execution Rejection and an impact level is “High”, for example, 4W1H information, the definition information of a subsequent job, the operation record of the job, the definition information (such as schedule settings) of the job useful for the execution rejection investigation, and information on an assumed execution rejection factor are acquired. The operation record of the job is, for example, the multiplicity of jobs at the time of error occurrence, and the multiplicity is obtained as illustrated in FIG. 18.

The definition information of the job useful for the execution rejection investigation is, for example, schedule settings (scheduled start time of the job and scheduled end time of the job). The information on an assumed execution rejection factor is, for example, the status of the job before the execution rejection occurs, the start condition (scheduled start time) of the job, and others.

For example, the information collection unit 145 transmits an information acquisition request including the job name of the job that is the source of the error and a timestamp indicating the error occurrence time, to the job execution management unit 130. The job execution management unit 130 then returns the schedule settings of the job identified by the job name, the status of the job before the execution rejection occurs, the start condition (including the scheduled start time), and others to the information collection unit 145.

The information collection unit 145 sets the acquired information in the trouble information 42. The information collection unit 145 performs an assumed execution rejection factor analysis on the basis of the acquired information, and includes the analysis result in the trouble information 42.

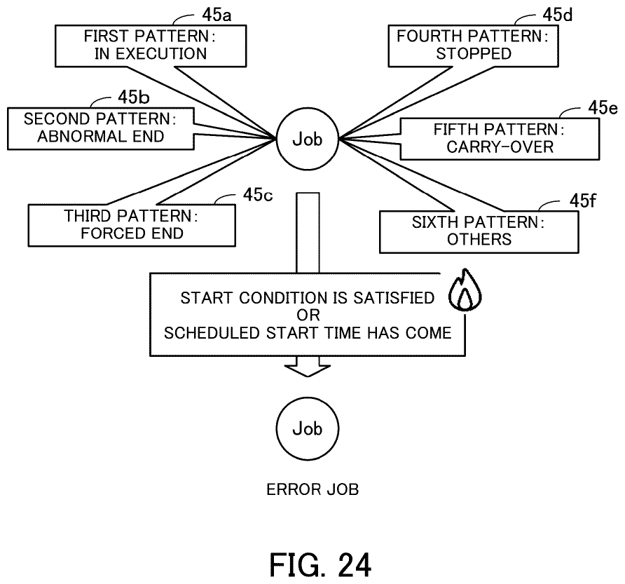

FIG. 24 illustrates an example of an assumed execution rejection factor analysis. Assumed factor patterns include a first pattern 45a, a second pattern 45b, a third pattern 45c, a fourth pattern 45d, a fifth pattern 45e, and a sixth pattern 45f including other patterns. The first pattern 45a is a pattern in which the error occurs because the start condition of a job is satisfied again (including the arrival of the scheduled start time) while the job is in execution. The second pattern 45b is a pattern in which the error occurs because the start condition of a job is satisfied while the job is in an abnormal end state. The third pattern 45c is a pattern in which the error occurs because the start condition of a job is satisfied while the job is in a forced end state. The fourth pattern 45d is a pattern in which the error occurs because the start condition of a job is satisfied two or more times while the job is in a stopped state. The fifth pattern 45e is a pattern in which the error occurs because the scheduled start time of a job in a carry-over state has come.

The information collection unit 145 determines, based on the acquired information, whether the trouble in question falls under any of the assumed factor patterns. If the trouble in question falls under an assumed factor pattern, the information collection unit 145 sets the assumed execution rejection factor indicated by the assumed factor pattern, in the trouble information 42.

Information to be collected for a trouble having the trouble type of Execution Skip and the impact level of “Low” is the same as that for a trouble having the trouble type of Abnormal End and the impact level of “Low” (see FIG. 16). Information to be collected for a trouble having the trouble type of Execution Skip and the impact level of “Medium” is the same as that for a trouble having the trouble type of Abnormal End and the impact level of “Medium” (see FIG. 17).

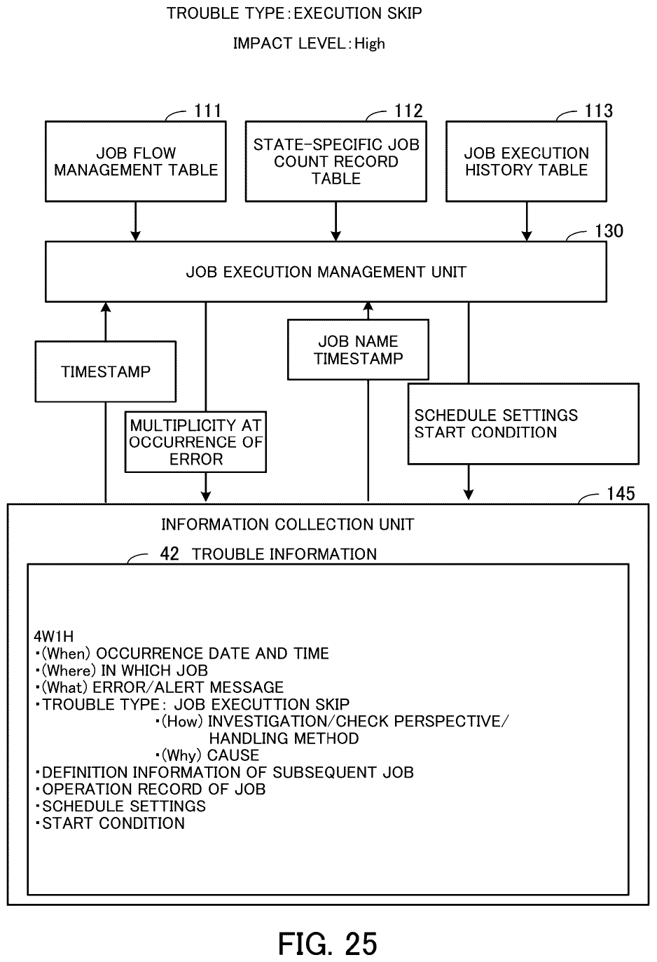

FIG. 25 illustrates an example of information collection for a trouble having the trouble type of “Execution Skip” and the impact level of “High”. In the case where a trouble type is Execution Skip and an impact level is “High”, for example, 4W1H information, the definition information of a subsequent job, the operation record of the job, and the definition information (schedule settings, etc.) of the job useful for the execution skip investigation are collected. The operation record of the job is, for example, the multiplicity of jobs at the time of error occurrence, and the multiplicity is obtained as illustrated in FIG. 18. The definition information of the job useful for the execution skip investigation is, for example, schedule settings (scheduled start time of the job, scheduled end time of the job), a start condition, and others.

For example, the information collection unit 145 transmits an information acquisition request including the job name of the job that is the source of the error and a timestamp indicating the error occurrence time, to the job execution management unit 130. The job execution management unit 130 then returns the schedule settings and the start condition of the job identified by the job name to the information collection unit 145. The information collection unit 145 sets the acquired information in the trouble information 42.

When an error alert message is outputted from the managed system 31, the information collection and the assumed factor analysis are performed as described above, and appropriate incident information is generated taking into account information such as trouble type.

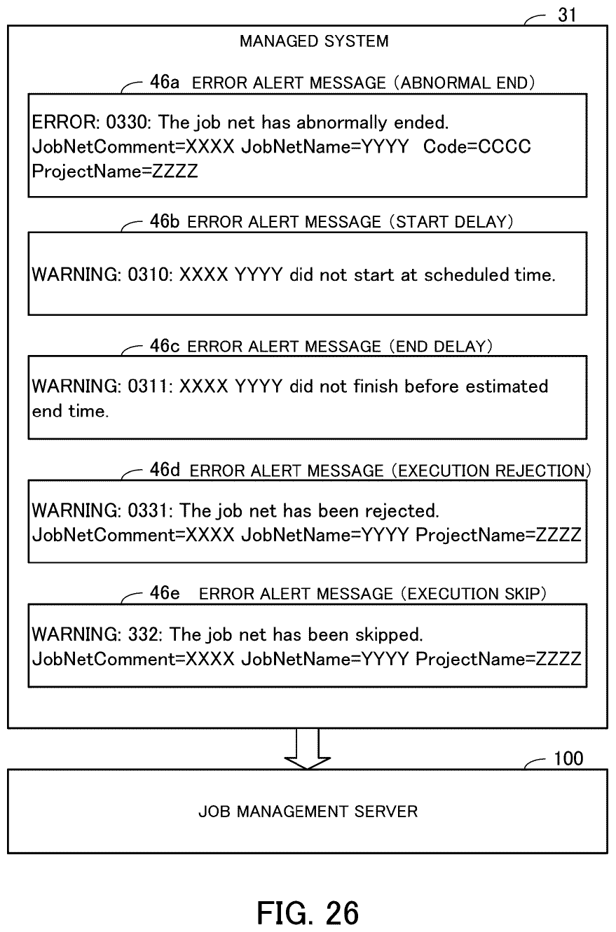

FIG. 26 illustrates an example of an error alert message for each trouble type. When troubles occur during the execution of jobs, the managed system 31 outputs error alert messages 46a to 46e including information on the troubles. The error alert message 46a that is output when a job has abnormally ended includes a type code “0330” indicating the trouble type of “Abnormal End”. The error alert message 46b that is output when the start of a job is delayed includes a type code “0310” indicating the trouble type of “Start Delay”. The error alert message 46c that is output when the end of a job is delayed includes a type code “0311” indicating the trouble type of “End Delay”. The error alert message 46d that is output when the execution of a job is rejected includes a type code “0331” indicating the trouble type of “Execution Rejection”. The error alert message 46e that is output when the execution of a job is skipped includes a type code “0332” indicating the trouble type of “Execution Skip”.

The error alert messages 46 a to 46 e (telegrams) each include an error message (character string) indicating the details of an error. For example, in the error alert message 46a, the following error message is set: “The job net has abnormally ended.” In addition to the trouble type of a trouble, a trouble name that further subdivides the details of the trouble is set in each error alert message 46a to 46e. For example, a value set in “Code =” is a trouble name.

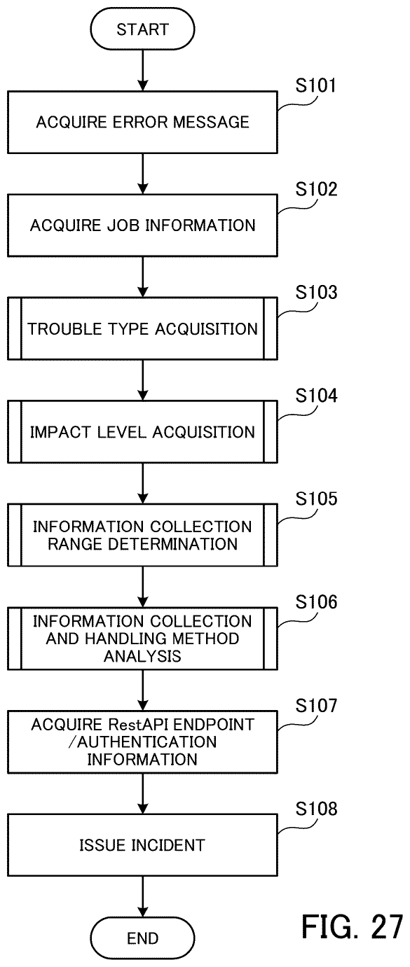

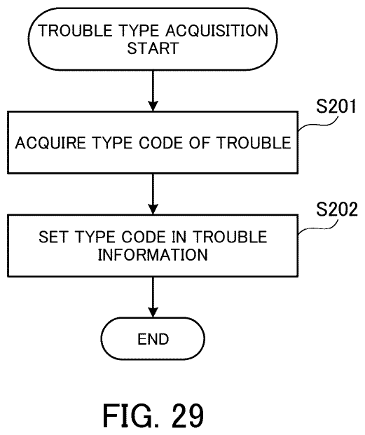

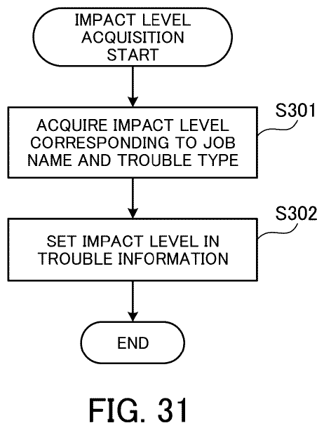

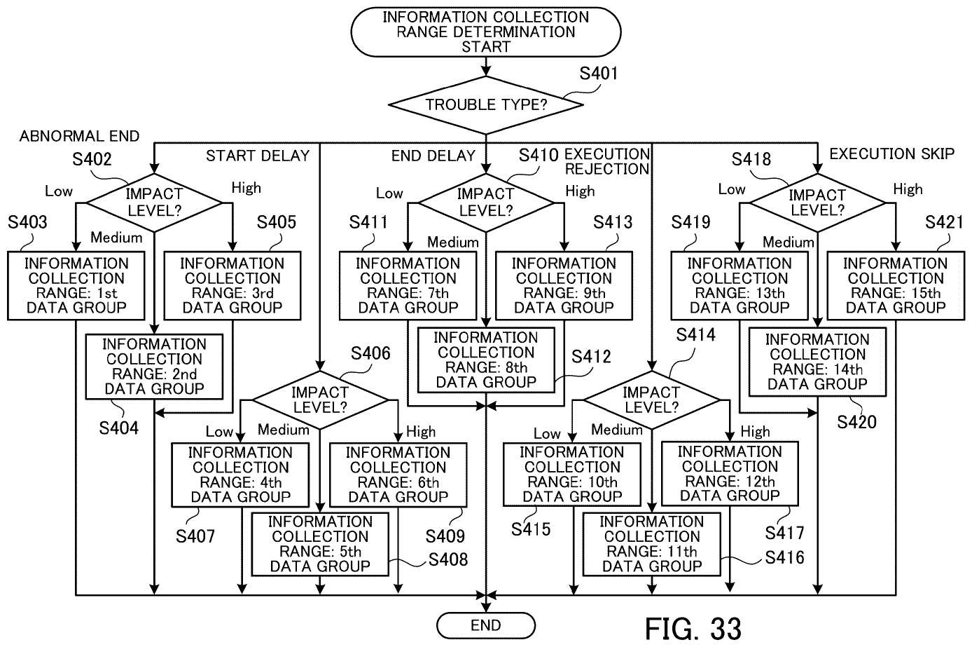

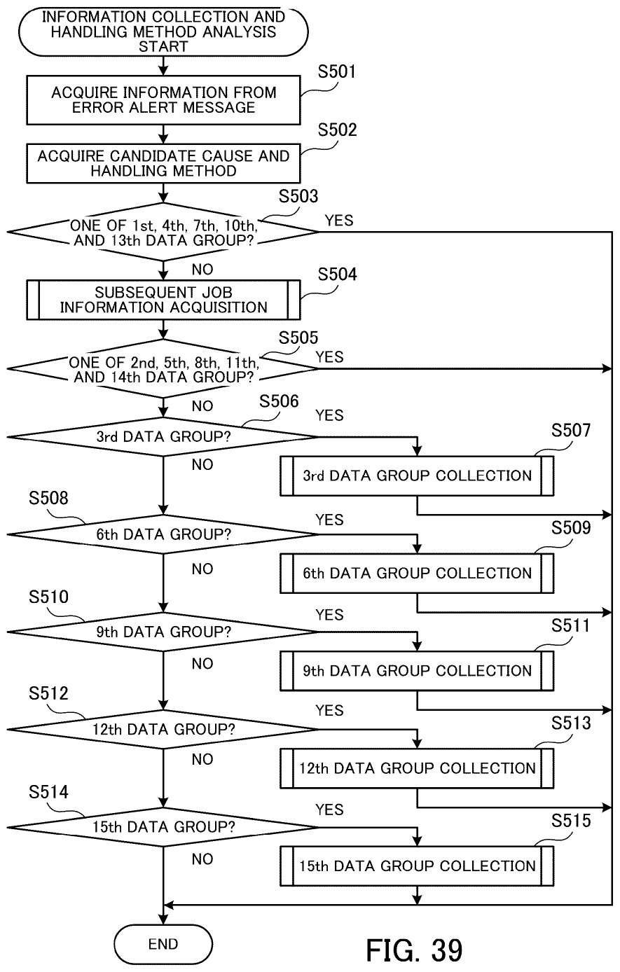

FIG. 27 is a flowchart illustrating an example procedure for an incident monitoring process. Hereinafter, the process illustrated in FIG. 27 will be described step by step.

[Step S101] The failure reception unit 141 acquires an error message from an error alert message received via the job execution management unit 130. The failure reception unit 141 sets the acquired error message in trouble information (TROUBLE_INFOMESSAGE=error message).

[Step S102] The failure reception unit 141 acquires job information (e.g., job name) of a job that is an error detection target, from the error alert message. For example, the failure reception unit 141 sets the acquired job information in the trouble information (TROUBLE_INFO.JOB_NAME=job name).

[Step S103] The failure diagnosis unit 142 acquires the trouble type of the job, based on the error alert message. Details of the trouble type acquisition process will be described later (see FIG. 29).

[Step S104] The impact level determination unit 143 acquires the impact level of the trouble that has occurred, on the overall system, based on the job name and the trouble type. Details of the impact level acquisition process will be described later (see FIG. 31).

[Step S105] The information collection range determination unit 144 determines an information collection range, based on the impact level on the overall system. Details of the information collection range determination process will be described later (see FIG. 33).

[Step S106] The information collection unit 145 collects information according to the trouble type of the job or information on a handling method, and performs handling method analysis. Details of the information collection and handling method analysis process will be described later (see FIG. 39).

[Step S107] The incident issuing unit 146 acquires the RestAPI endpoint/authentication information of an incident destination (ITSM server 32).

[Step S108] The incident issuing unit 146 transmits incident information including the content of the trouble information to the ITSM server 32 via RestAPI.

Through the above procedure, an incident relating to the trouble that has occurred is issued. Information on the trouble that has occurred is temporarily collected as the trouble information.

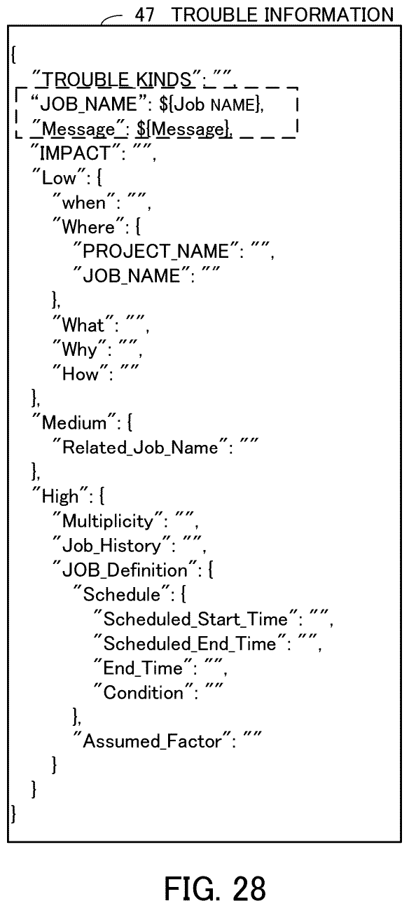

FIG. 28 illustrates an example of trouble information. Trouble information 47 is, for example, a structured document. For example, after an error message is acquired, the acquired error message is set as the value of “Message” in the trouble information 47. After job information is acquired, the acquired job information (job name) is set as the value of “JOB_NAME” in the trouble information 47.

After the error message and the job information are acquired, the trouble type acquisition process is performed.

FIG. 29 is a flowchart illustrating an example procedure for the trouble type acquisition process. Hereinafter, the process illustrated in FIG. 29 will be described step by step.

[Step S201] The failure diagnosis unit 142 acquires a type code indicating a trouble type from the error message. The type code is, for example, a numerical string following “WARNING” or “ERROR”.

[Step S202] The failure diagnosis unit 142 sets the type code of the trouble type in the trouble information (TROUBLE_INFO.TROUBLE_KINDS=Type code).

In the manner described above, the type code of the trouble type is acquired, and the acquired type code is set in the trouble information 47.

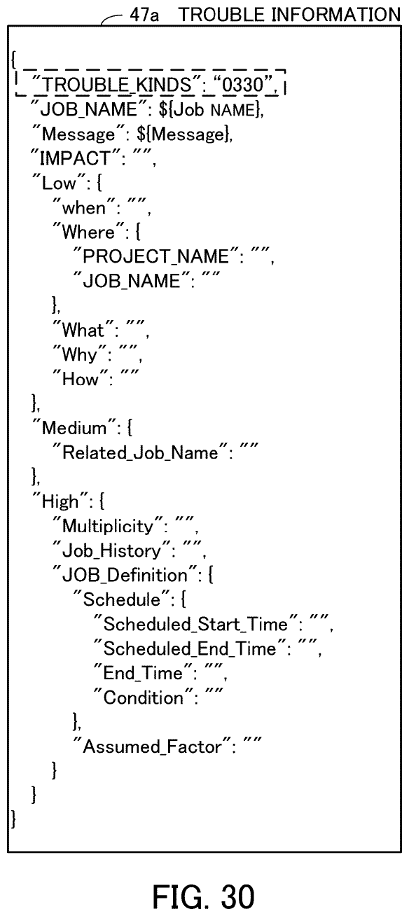

FIG. 30 illustrates an example of trouble information in which a type code is set. In the example of FIG. 30, a type code “0330” is set in the trouble information 47a. This type code indicates that the trouble type is Abnormal End.

After the trouble type is acquired, the impact level acquisition process is performed next.

FIG. 31 is a flowchart illustrating an example procedure for the impact level acquisition process. Hereinafter, the process illustrated in FIG. 31 will be described step by step.

[Step S301] The impact level determination unit 143 acquires the impact level corresponding to the combination of the job name and the trouble type. For example, the impact level determination unit 143 refers to the impact level management table 121 to search for a record corresponding to the combination of the job name and the type code indicated in the trouble information. The impact level determination unit 143 acquires the impact level indicated in the found record.

[Step S302] The impact level determination unit 143 sets the acquired impact level in the trouble information (TROUBLE_INFO.IMPACT=Impact level). The impact level to be set is “High”, “Medium”, or “Low”.

In the manner described above, the impact level of the trouble, which has occurred, on the overall system is acquired, and the acquired impact level is set in the trouble information.

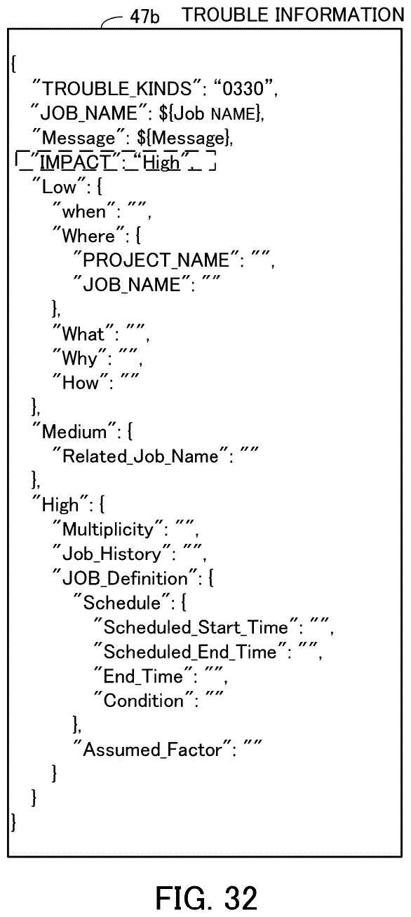

FIG. 32 illustrates an example of trouble information in which an impact level is set. In the example of FIG. 32, a trouble type is Abnormal End (TROUBLE_KINDS=0330). Assume, for example, that a job name is job B. The impact level determination unit 143 acquires the impact level “High” corresponding to the trouble type of Abnormal End and the job name of job B, with reference to the impact level management table 121 illustrated in FIG. 10. As a result, the impact level “High” is set in trouble information 47b (“IMPACT”=“High”). After the impact level is acquired, the information collection range determination process is performed.

FIG. 33 is a flowchart illustrating an example procedure for the information collection range determination process. Hereinafter, the process illustrated in FIG. 33 will be described step by step.

[Step S401] The information collection range determination unit 144 determines a trouble type. For example, the information collection range determination unit

144 acquires the type code set in “TROUBLE _KINDS” of trouble information. If the information collection range determination unit 144 acquires a type code of Abnormal End, the process proceeds to step S402. If the information collection range determination unit 144 acquires a type code of Start Delay, the process proceeds to step S406. If the information collection range determination unit 144 acquires a type code of End Delay, the process proceeds to step S410. If the information collection range determination unit 144 acquires a type code of Execution Rejection, the process proceeds to step S414. If the information collection range determination unit 144 acquires a type code of Execution Skip, the process proceeds to step S418.

[Step S402] The information collection range determination unit 144 determines the impact level. For example, the information collection range determination unit 144 acquires a character string set in “IMPACT” of the trouble information. If the impact level is “Low”, the process proceeds to step S403. If the impact level is “Medium”, the process proceeds to step S404. If the impact level is “High”, the process proceeds to step S405.

[Step S403] The information collection range determination unit 144 sets a first data group as the information collection range. For example, the information collection range determination unit 144 sets a value (NONE) indicating exclusion, for information that is not included in the first data group among collectable information indicated in the trouble information. Thereafter, the information collection range determination unit 144 completes the information collection range determination process.

[Step S404] the Information Collection Range determination unit 144 sets a second data group as the information collection range. For example, the information collection range determination unit 144 sets a value (NONE) indicating exclusion, for information that is not included in the second data group among the collectable information indicated in the trouble information. Thereafter, the information collection range determination unit 144 completes the information collection range determination process.

[Step S405] The information collection range determination unit 144 sets a third data group as the information collection range. For example, the information collection range determination unit 144 sets a value (NONE) indicating exclusion, for information that is not included in the third data group among the collectable information indicated in the trouble information. Thereafter, the information collection range determination unit 144 completes the information collection range determination process.

[Step S406] The information collection range determination unit 144 determines the impact level. If the impact level is “Low”, the process proceeds to step S407. If the impact level is “Medium”, the process proceeds to step S408. If the impact level is “High”, the process proceeds to step S409.

[Step S407] the Information Collection Range determination unit 144 sets a fourth data group as the information collection range. For example, the information collection range determination unit 144 sets a value (NONE) indicating exclusion, for information that is not included in the fourth data group among the collectable information indicated in the trouble information. Thereafter, the information collection range determination unit 144 completes the information collection range determination process.

[Step S408] The information collection range determination unit 144 sets a fifth data group as the information collection range. For example, the information collection range determination unit 144 sets a value (NONE) indicating exclusion, for information that is not included in the fifth data group among the collectable information indicated in the trouble information. Thereafter, the information collection range determination unit 144 completes the information collection range determination process.

[Step S409] The information collection range determination unit 144 sets a sixth data group as the information collection range. For example, the information collection range determination unit 144 sets a value (NONE) indicating exclusion, for information that is not included in the sixth data group among the collectable information indicated in the trouble information. Thereafter, the information collection range determination unit 144 completes the information collection range determination process.

[Step S410] The information collection range determination unit 144 determines the impact level. If the impact level is “Low”, the process proceeds to step S411. If the impact level is “Medium”, the process proceeds to step S412. If the impact level is “High”, the process proceeds to step S413.

[Step S411] The information collection range determination unit 144 sets a seventh data group as the information collection range. For example, the information collection range determination unit 144 sets a value (NONE) indicating exclusion, for information that is not included in the seventh data group among the collectable information indicated in the trouble information. Thereafter, the information collection range determination unit 144 completes the information collection range determination process.

[Step S412] The information collection range determination unit 144 sets an eighth data group as the information collection range. For example, the information collection range determination unit 144 sets a value (NONE) indicating exclusion, for information that is not included in the eighth data group among the collectable information indicated in the trouble information. Thereafter, the information collection range determination unit 144 completes the information collection range determination process.

[Step S413] The information collection range determination unit 144 sets a ninth data group as the information collection range. For example, the information collection range determination unit 144 sets a value (NONE) indicating exclusion, for information that is not included in the ninth data group among the collectable information indicated in the trouble information. Thereafter, the information collection range determination unit 144 completes the information collection range determination process.

[Step S414] The information collection range determination unit 144 determines the impact level. If the impact level is “Low”, the process proceeds to step S415. If the impact level is “Medium”, the process proceeds to step S416. If the impact level is “High”, the process proceeds to step S417.

[Step S415] The information collection range determination unit 144 sets a tenth data group as the information collection range. For example, the information collection range determination unit 144 sets a value (NONE) indicating exclusion, for information that is not included in the tenth data group among the collectable information indicated in the trouble information. Thereafter, the information collection range determination unit 144 completes the information collection range determination process.

[Step S416] The information collection range determination unit 144 sets an eleventh data group as the information collection range. For example, the information collection range determination unit 144 sets a value (NONE) indicating exclusion, for information that is not included in the eleventh data group among the collectable information indicated in the trouble information. Thereafter, the information collection range determination unit 144 completes the information collection range determination process.

[Step S417] The information collection range determination unit 144 sets a twelfth data group as the information collection range. For example, the information collection range determination unit 144 sets a value (NONE) indicating exclusion, for information that is not included in the twelfth data group among the collectable information indicated in the trouble information. Thereafter, the information collection range determination unit 144 completes the information collection range determination process.

[Step S418] The information collection range determination unit 144 determines the impact level. If the impact level is “Low”, the process proceeds to step S419. If the impact level is “Medium”, the process proceeds to step S420. If the impact level is “High”, the process proceeds to step S421.

[Step S419] The information collection range determination unit 144 sets a thirteenth data group as the information collection range. For example, the information collection range determination unit 144 sets a value (NONE) indicating exclusion, for information that is not included in the thirteenth data group among the collectable information indicated in the trouble information. Thereafter, the information collection range determination unit 144 completes the information collection range determination process.

[Step S420] The information collection range determination unit 144 sets a fourteenth data group as the information collection range. For example, the information collection range determination unit 144 sets a value (NONE) indicating exclusion, for information that is not included in the fourteenth data group among the collectable information indicated in the trouble information. Thereafter, the information collection range determination unit 144 completes the information collection range determination process.

[Step S421] The information collection range

determination unit 144 sets a fifteenth data group as the information collection range. For example, the information collection range determination unit 144 sets a value (NONE) indicating exclusion, for information that is not included in the fifteenth data group among the collectable information indicated in the trouble information. Thereafter, the information collection range determination unit 144 completes the information collection range determination process.

In the manner described above, the information collection range corresponding to the trouble type and the impact level is determined. Then, information specified by the determined information collection range is set in the trouble information.

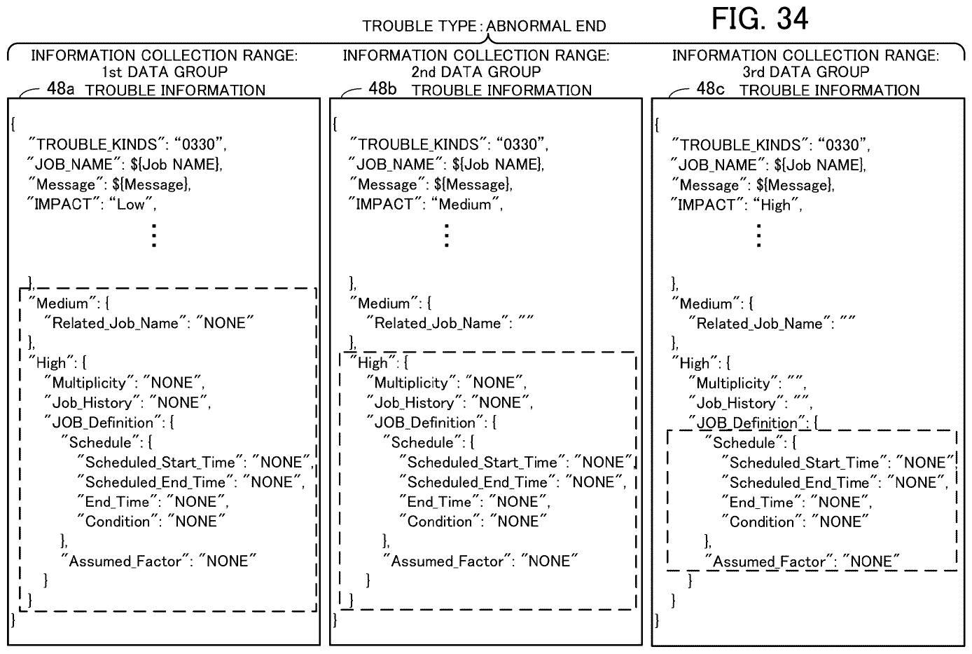

FIG. 34 illustrates examples of trouble information in which an information collection range for the trouble type of “Abnormal End” is set. In trouble information 48a to 48c, the items within the range enclosed by a dashed rectangle are those whose values are set according to the determined information collection range. The trouble information 48a includes values that are set according to the information collection range (first data group) for the trouble type of Abnormal End and the impact level of “Low”. The trouble information 48b includes values that are set according to the information collection range (second data group) for the trouble type of Abnormal End and the impact level of “Medium”. The trouble information 48c includes values that are set according to the information collection range (third data group) for the trouble type of Abnormal End and the impact level of “High”.

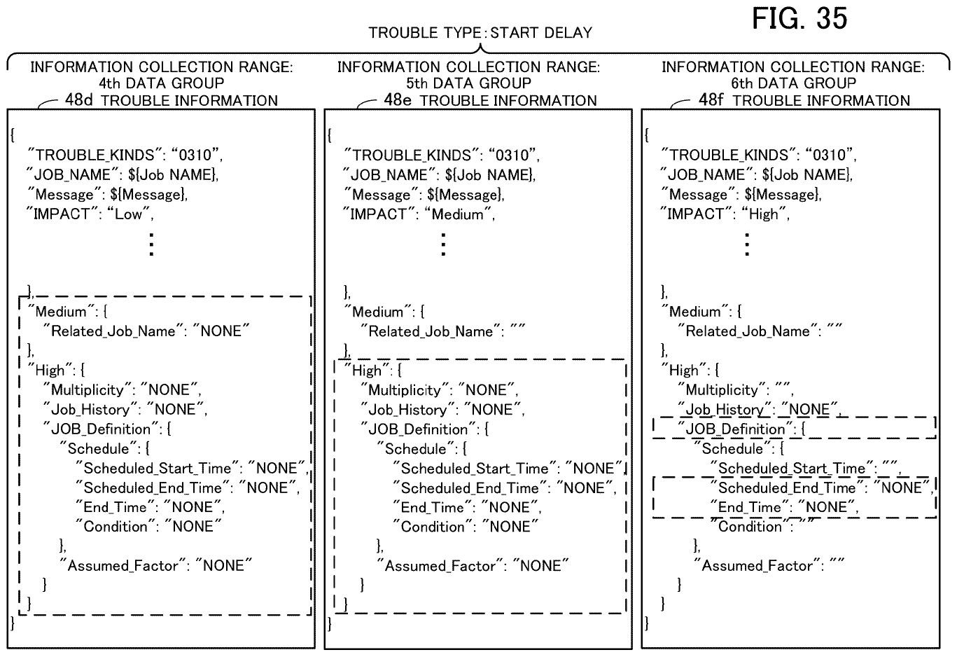

FIG. 35 illustrates examples of trouble information in which an information collection range for the trouble type of “Start Delay” is set. In trouble information 48d to 48f, the items within the range enclosed by a dashed rectangle are those whose values are set according to the determined information collection range. The trouble information 48d includes values that are set according to the information collection range (fourth data group) for the trouble type of Start Delay and the impact level of “Low”. The trouble information 48e includes values that are set according to the information collection range (fifth data group) for the trouble type of Start Delay and the impact level of “Medium”. The trouble information 48f includes values that are set according to the information collection range (sixth data group) for the trouble type of Start Delay and the impact level of “High”.

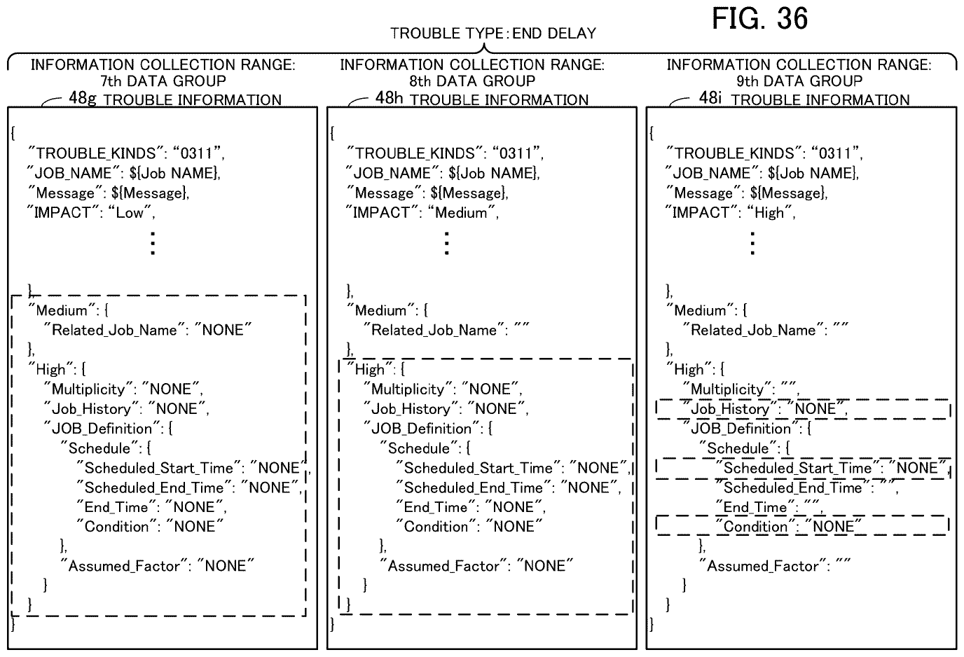

FIG. 36 illustrates examples of trouble information in which an information collection range for the trouble type of “End Delay” is set. In trouble information 48g to 48i, the items within the range enclosed by a dashed rectangle are those whose values are set according to the determined information collection range. The trouble information 48g includes values that are set according to the information collection range (seventh data group) for the trouble type of “End Delay” and the impact level of “Low”. The trouble information 48h includes values that are set according to the information collection range (eighth data group) for the trouble type of “End Delay” and the impact level of “Medium”. The trouble information 48i includes values that are set according to the information collection range (ninth data group) for the trouble type of “End Delay” and the impact level of “High”.

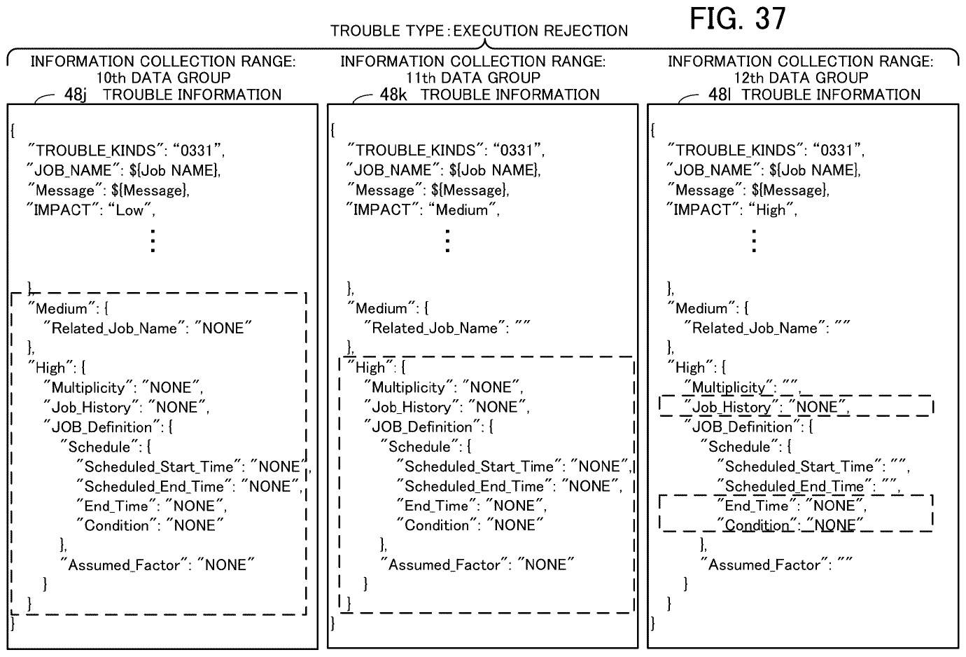

FIG. 37 illustrates examples of trouble information in which an information collection range for the trouble type of “Execution Rejection” is set. In trouble information 48j to 48l, the items within the range enclosed by a dashed rectangle are those whose values are set according to the determined information collection range. The trouble information 48j includes values that are set according to the information collection range (tenth data group) for the trouble type of “Execution Rejection” and the impact level of “Low”. The trouble information 48k includes values that are set according to the information collection range (eleventh data group) for the trouble type of Execution Rejection and the impact level of “Medium”. The trouble information 48l includes values that are set according to the information collection range (twelfth data group) for the trouble type of Execution Rejection and the impact level of “High”.

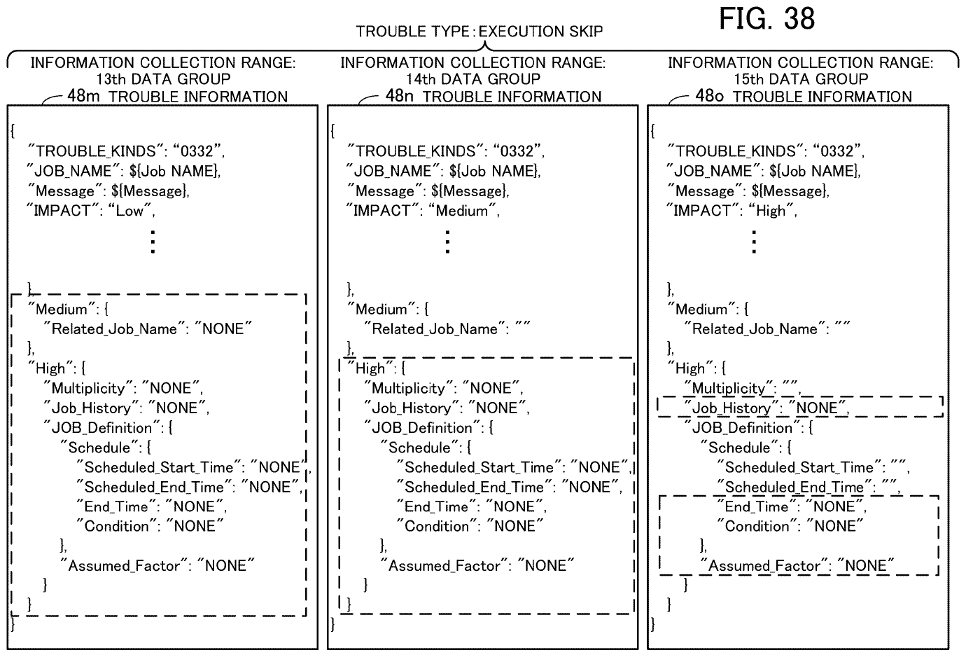

FIG. 38 illustrates examples of trouble information in which an information collection range for the trouble type of “Execution Skip” is set. In trouble information 48m to 48o, the items within the range enclosed by a dashed rectangle are those whose values are set according to the determined information collection range. The trouble information 48m includes values that are set according to the information collection range (thirteenth data group) for the trouble type of Execution Skip and the impact level of “Low”. The trouble information 48n includes values that are set according to the information collection range (fourteenth data group) for the trouble type of Execution Skip and the impact level of “Medium”. The trouble information 48o includes values that are set according to the information collection range (fifteenth data group) for the trouble type of Execution Skip and the impact level of “High”.

After the information collection range is determined, the information collection and handling method analysis are performed based on the determined information collection range.

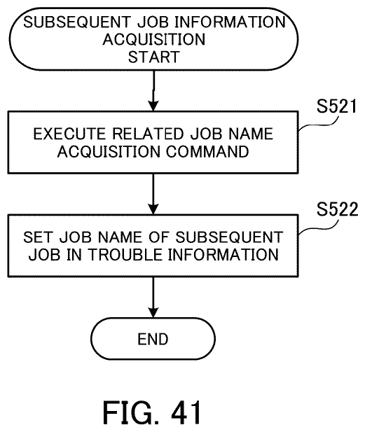

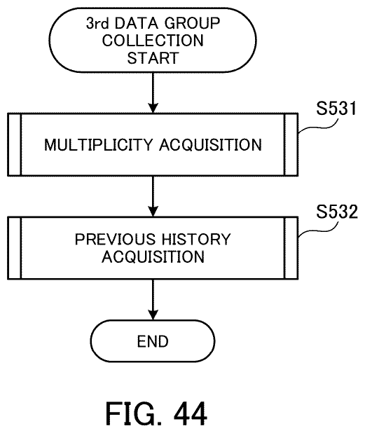

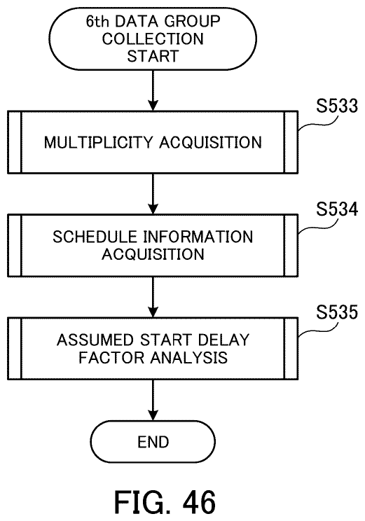

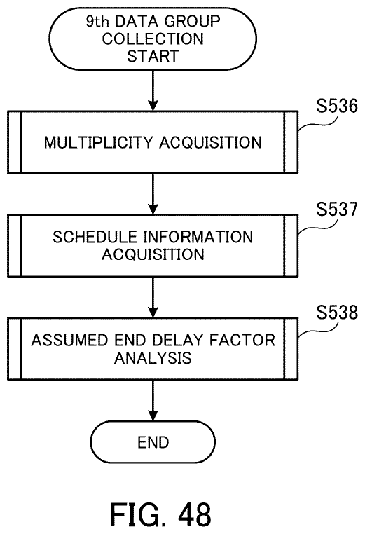

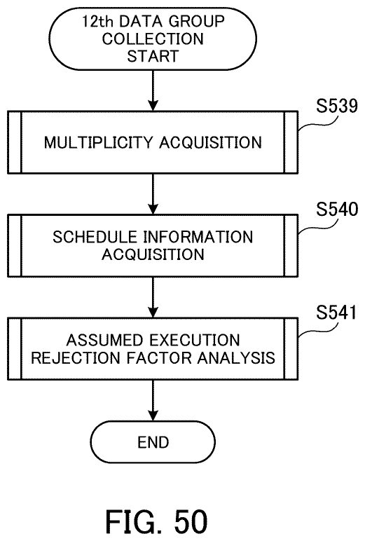

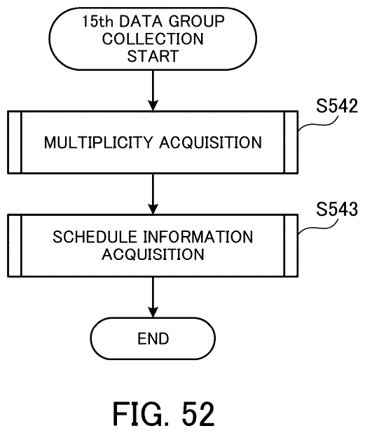

FIG. 39 is a flowchart illustrating an example procedure for the information collection and handling method analysis process. Hereinafter, the process illustrated in FIG. 39 will be described step by step.

[Step S501] The information collection unit 145 acquires information from an error alert message. For example, the information collection unit 145 acquires information such as a trouble occurrence date and time, a project name, a job name, an error message (a character string indicating the details of the error), and a trouble name from the error alert message.

[Step S502] The information collection unit 145 acquires a candidate cause and a handling method corresponding to the trouble that has occurred. For example, the information collection unit 145 acquires, from the handling method management table 122, a candidate cause and a handling method corresponding to the combination of the trouble type set in the trouble information and the trouble name acquired from the error alert message.

[Step S503] The information collection unit 145 determines whether the information collection range is one of the first data group, the fourth data group, the seventh data group, the tenth data group, and the thirteenth data group. For example, the information collection unit 145 refers to the trouble information, and if the impact level is “Low”, determines that the information collection range is one of these. If it is determined that the information collection range is one of these, the information collection unit 145 completes the information collection and handling method analysis process. If it is determined that the information collection range is none of these, the process proceeds to step S504.

[Step S504] The information collection unit 145 performs a subsequent job information acquisition process. Details of the subsequent job information acquisition process will be described later (see FIG. 41).

[Step S505] The information collection unit 145 determines whether the information collection range is one of the second data group, the fifth data group, the eighth data group, the eleventh data group, and the fourteenth data group. For example, the information collection unit 145 refers to the trouble information, and if the impact level is “Medium”, determines that the information collection range is one of these. If it is determined that the information collection range is one of these, the information collection unit 145 completes the information collection and handling method analysis process. If it is determined that the information collection range is none of these, the process proceeds to step S506.

[Step S506] The information collection unit 145 determines whether the information collection range is the third data group. For example, the information collection unit 145 refers to the trouble information, and if the trouble type is Abnormal End and the impact level is “High”, determines that the information collection range is the third data group. If it is determined that the information collection range is the third data group, the process proceeds to step S507. If it is determined that the information collection range is not the third data group, the process proceeds to step S508.

[Step S507] The information collection unit 145 performs a third data group collection process. Details of the third data group collection process will be described later (see FIG. 44). Thereafter, the information collection unit 145 completes the information collection and handling method analysis process.

[Step S508] The information collection unit 145 determines whether the information collection range is the sixth data group. For example, the information collection unit 145 refers to the trouble information, and if the trouble type is Start Delay and the impact level is “High”, determines that the information collection range is the sixth data group. If it is determined that the information collection range is the sixth data group, the process proceeds to step S509. If it is determined that the information collection range is not the sixth data group, the process proceeds to step S510.

[Step S509] The information collection unit 145 performs a sixth data group collection process. Details of the sixth data group collection process will be described later (see FIG. 46). Thereafter, the information collection unit 145 completes the information collection and handling method analysis process.

[Step S510] The information collection unit 145 determines whether the information collection range is the ninth data group. For example, the information collection unit 145 refers to the trouble information, and if the trouble type is End Delay and the impact level is “High”, determines that the information collection range is the ninth data group. If it is determined that the information collection range is the ninth data group, the process proceeds to step S511. If the information collection range is not the ninth data group, the process proceeds to step S512.

[Step S511] The information collection unit 145 performs a ninth data group collection process. Details of the ninth data group collection process will be described later (see FIG. 48). Thereafter, the information collection unit 145 completes the information collection and handling method analysis process.

[Step S512] The information collection unit 145 determines whether the information collection range is the twelfth data group. For example, the information collection unit 145 refers to the trouble information, and if the trouble type is Execution Rejection and the impact level is “High”, determines that the information collection range is the twelfth data group. If it is determined that the information collection range is the twelfth data group, the process proceeds to step S513. If it is determined that the information collection range is not the twelfth data group, the process proceeds to step S514.

[Step S513] The information collection unit 145 performs a twelfth data group collection process. Details of the twelfth data group collection process will be described later (see FIG. 50). Thereafter, the information collection unit 145 completes the information collection and handling method analysis process.

[Step S514] The information collection unit 145 determines whether the information collection range is the fifteenth data group. For example, the information collection unit 145 refers to the trouble information, and if the trouble type is Execution Skip and the impact level is “High”, determines that the information collection range is the fifteenth data group. If it is determined that the information collection range is the fifteenth data group, the process proceeds to step S515. If it is determined that the information collection range is not the fifteenth data group, the information collection unit 145 completes the information collection and handling method analysis process.

[Step S515] The information collection unit 145 performs a fifteenth data group collection process. Details of the fifteenth data group collection process will be described later (see FIG. 52). Thereafter, the information collection unit 145 completes the information collection and handling method analysis process.

Through the above-described procedure, the data group collection process corresponding to a combination of a trouble type and an impact level is performed. It should be noted that the information collection of steps S501 and S502 is commonly performed for all combination patterns of trouble types and impact levels.

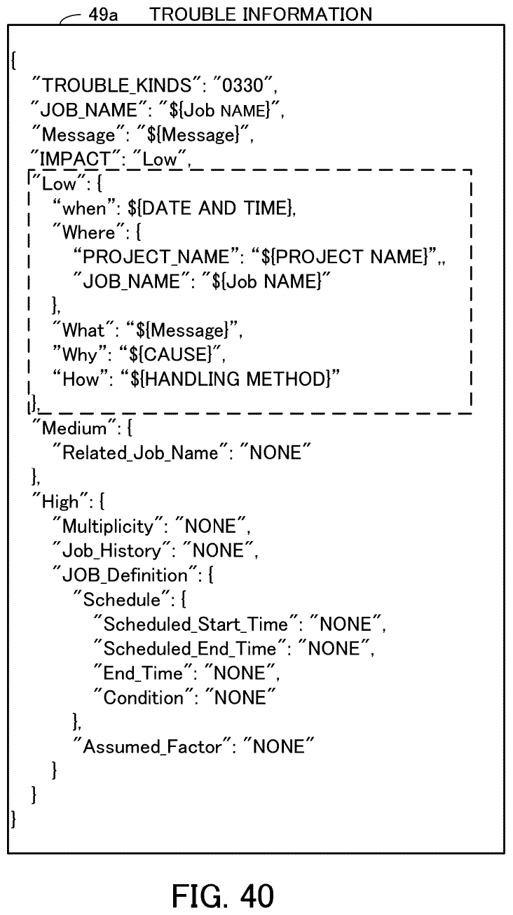

FIG. 40 illustrates an example of trouble information in which information collected in common is set. In trouble information 49a, the items within the range enclosed by a dashed rectangle are those for which information is collected in common in steps S501 and S502. For example, trouble occurrence date and time (when), project name (PROJECT_NAME), job name (JOB_NAME), error message (What), cause (Why), and handling method (How) are set in the trouble information 49a.

After information to be collected in common is collected, the subsequent job information acquisition process is further performed if the impact level is “Medium” or “High”.

FIG. 41 is a flowchart illustrating an example procedure for the subsequent job information acquisition process. Hereinafter, the process illustrated in FIG. 41 will be described step by step.

[Step S521] The information collection unit 145 causes the job execution management unit 130 to execute an acquisition command. For example, the information collection unit 145 transmits a related job name acquisition command specifying the job name of the job in which a trouble has occurred. In response to the related job name acquisition command, the job execution management unit 130 returns information including the job name of a related job of the job in which the trouble has occurred.

[Step S522] The information collection unit 145 sets the job name of a subsequent job of the job in which the trouble has occurred, in the trouble information.

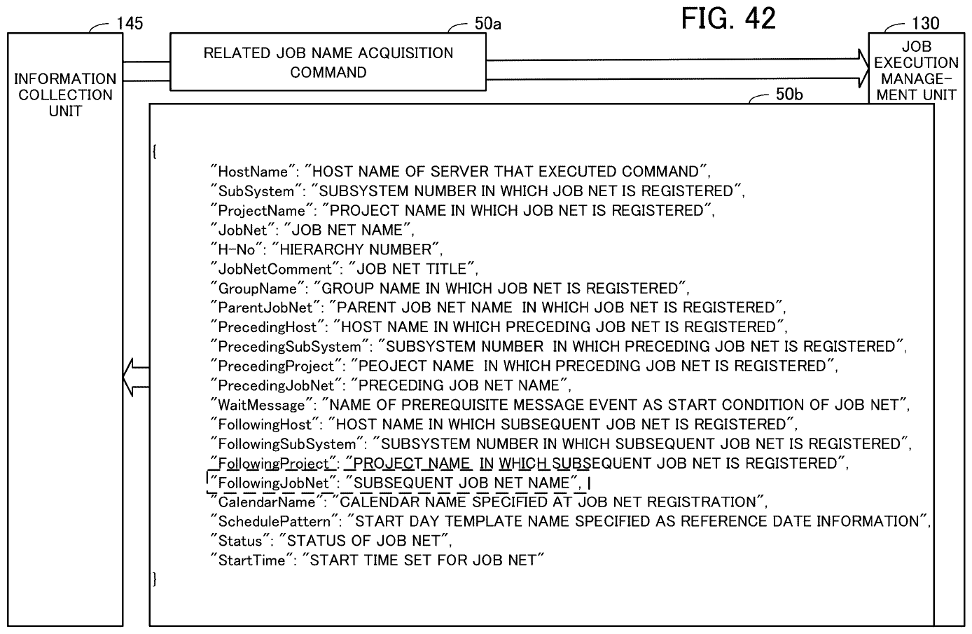

FIG. 42 illustrates an example of response data returned in response to a related job name acquisition command. When a related job name acquisition command 50a is transmitted from the information collection unit 145 to the job execution management unit 130, response data 50b as illustrated in FIG. 42 is returned from the job execution management unit 130. The response data 50b includes job information on the job in which the trouble has occurred. The response data 50b also includes the job name (which may be a job net name) of the subsequent job as the item “FollowingJobNet”. The acquired subsequent job information is set in the trouble information.

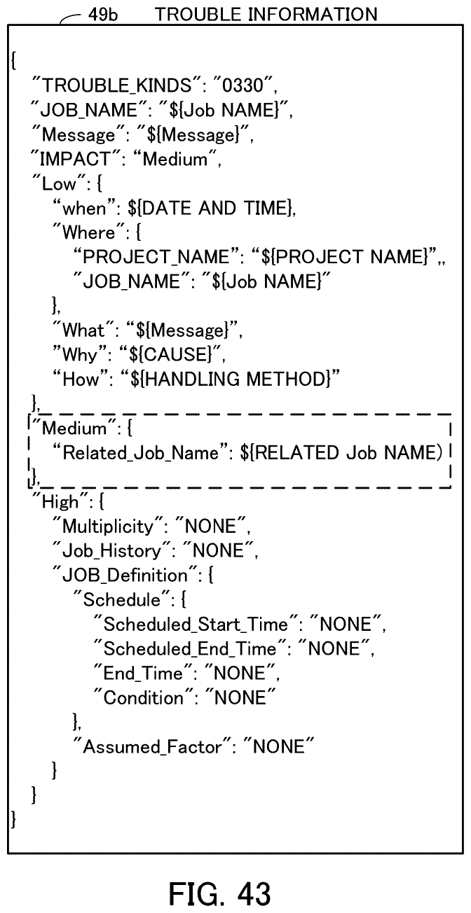

FIG. 43 illustrates an example of trouble information in which subsequent job information is set. In trouble information 49b, the item within the range enclosed by a dashed rectangle is an item in which the subsequent job information is set. For example, the trouble information 49b includes the job name of the subsequent job as a related job name (Related_Job_Name).

In the case where the impact level is “High”, information collection is further performed. The information collection range at this time depends on a trouble type. The following describes an information collection process for each trouble type in the case where the impact level is “High”, with reference to FIGS. 44 to 52.

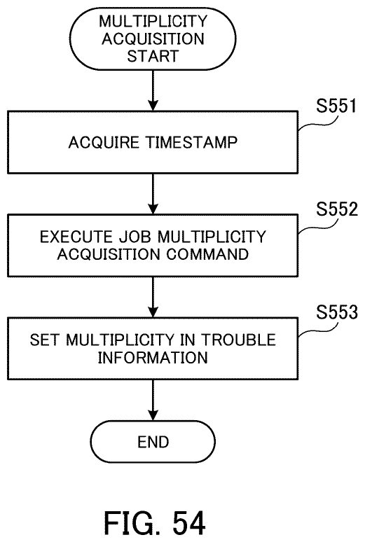

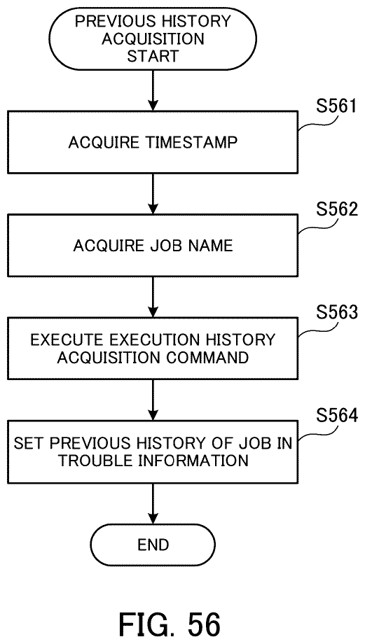

FIG. 44 is a flowchart illustrating an example procedure for the third data group collection process. For example, in the case where the impact level is “High” and the trouble type is Abnormal End, the third data group collection process is performed. Hereinafter, the process illustrated in FIG. 44 will be described step by step.

[Step S531] The information collection unit 145 performs a multiplicity acquisition process. As a result, the multiplicity of jobs in the managed system 31 during execution of the job in which the trouble has occurred is acquired. Details of the multiplicity acquisition process will be described later (see FIG. 54).

[Step S532] The information collection unit 145 performs a previous history acquisition process. By doing so, the last execution history of the troubled job prior to the occurrence of the trouble is acquired. Details of the previous history acquisition process will be described later (see FIG. 56).

In the manner described above, in the case where the impact level is “High” and the trouble type is Abnormal End, the multiplicity and the previous history are collected. The collected third data group (multiplicity and previous history) is set in the trouble information.

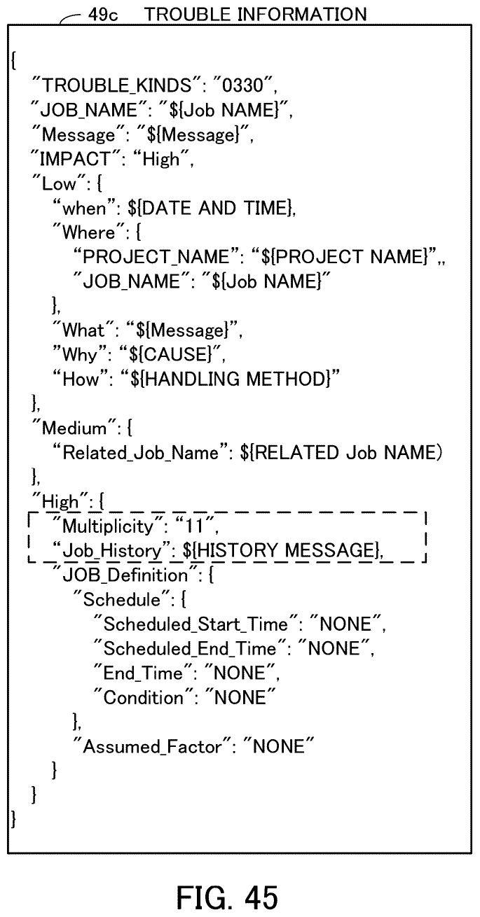

FIG. 45 illustrates an example of trouble information in which the third data group is set. In trouble information 49c, the items within the range enclosed by a dashed rectangle are those in which the multiplicity and the previous history are set. For example, the trouble information 49c includes a numerical value “11” indicating the acquired multiplicity as “Multiplicity”. The trouble information 49c also includes information indicating the previous history as a history message (Job_History).

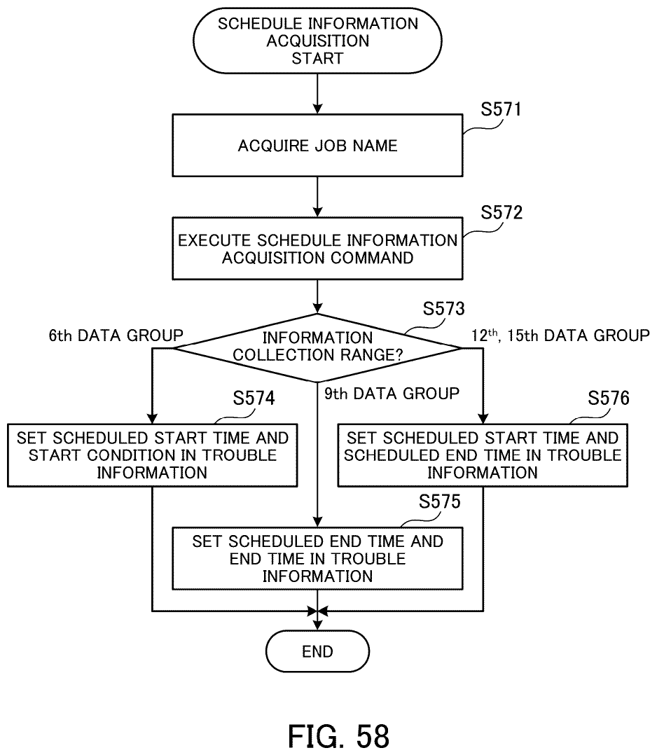

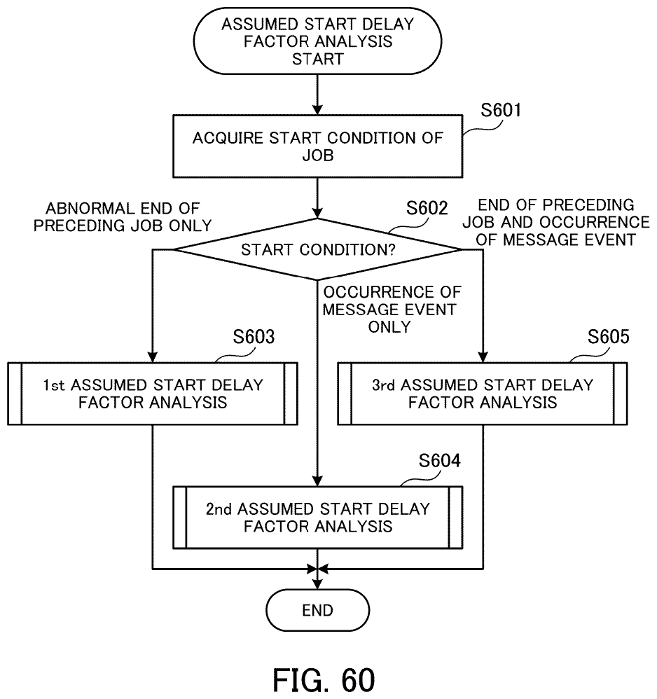

FIG. 46 is a flowchart illustrating an example procedure for the sixth data group collection process. For example, in the case where the impact level is “High” and the trouble type is Start Delay, the sixth data group collection process is performed. Hereinafter, the process illustrated in FIG. 46 will be described step by step.

[Step S533] The information collection unit 145 performs the multiplicity acquisition process.

[Step S534] The information collection unit 145 performs schedule information acquisition. Details of the schedule information acquisition process will be described later (see FIG. 58).

[Step S535] The information collection unit 145 performs an assumed start delay factor analysis process. Details of the assumed start delay factor analysis process will be described later (see FIG. 60).

In the manner described above, in the case where the impact level is “High” and the trouble type is Start Delay, the multiplicity and the schedule information are collected, and the assumed start delay factor analysis is further performed. The collected sixth data group (the multiplicity, the schedule information, and the result of the assumed start delay factor analysis) is set in the trouble information.

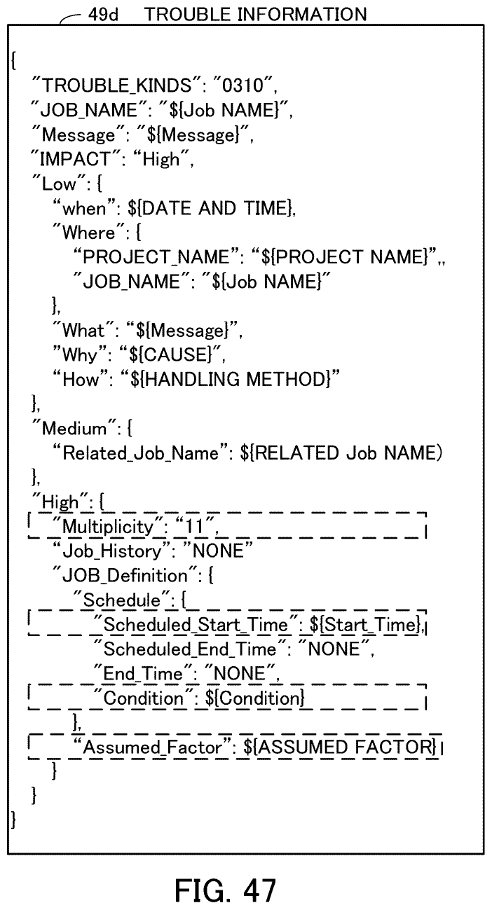

FIG. 47 illustrates an example of trouble information in which the sixth data group is set. In trouble information 49d, the items within the ranges enclosed by dashed rectangles are those in which the multiplicity and the schedule information are set. For example, the trouble information 49d includes a numerical value “11” indicating the acquired multiplicity as Multiplicity. The trouble information 49d also includes the job start time included in the acquired schedule information as the scheduled start time (Scheduled_Start_Time) of the job. The trouble information 49d also includes the start condition of the job included in the acquired schedule information as the start condition (Condition). In addition, the trouble information 49d includes the assumed start delay factor as the assumed factor (Assumed_Factor).

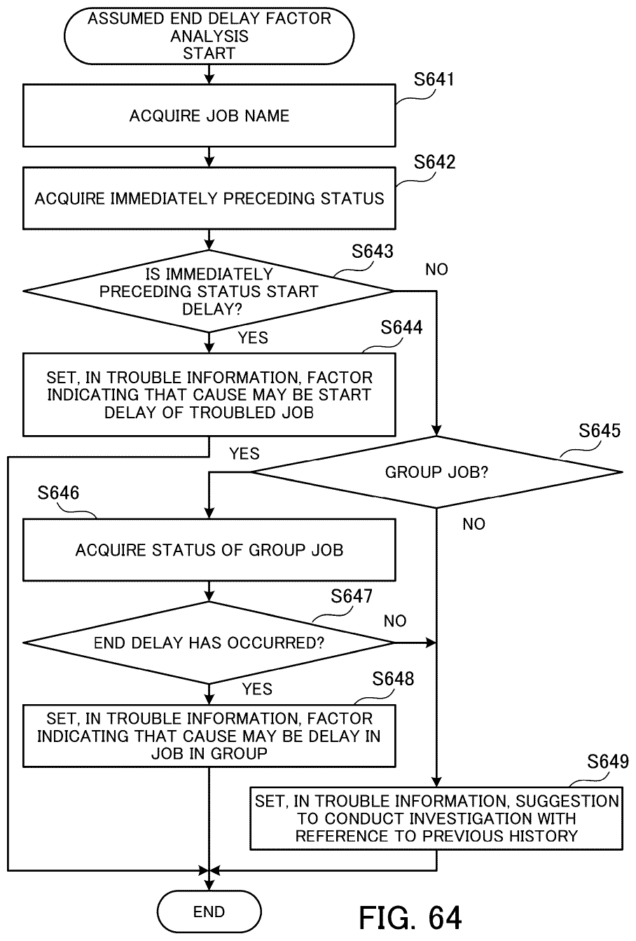

FIG. 48 is a flowchart illustrating an example procedure for the ninth data group collection process. For example, in the case where the impact level is “High” and the trouble type is End Delay, the ninth data group collection process is performed. Hereinafter, the process illustrated in FIG. 48 will be described step by step.

[Step S536] The information collection unit 145 performs the multiplicity acquisition process.

[Step S537] The information collection unit 145 performs the schedule information acquisition.

[Step S538] The information collection unit 145 performs an assumed end delay factor analysis process. Details of the assumed end delay factor analysis process will be described later (see FIG. 64).

In the manner described above, in the case where the impact level is “High” and the trouble type is End Delay, the multiplicity and the schedule information are collected, and the assumed end delay factor analysis is further performed. The collected ninth data group (the multiplicity, the schedule information, and the result of the assumed end delay factor analysis) is set in the trouble information.

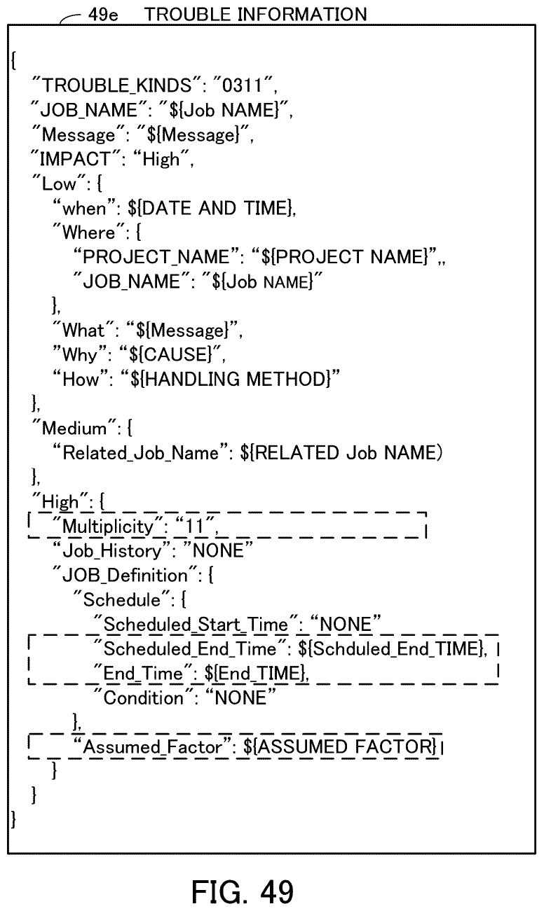

FIG. 49 illustrates an example of trouble information in which the ninth data group is set. In trouble information 49e, the items within the ranges enclosed by dashed rectangles are those in which the multiplicity and the schedule information are set. For example, the trouble information 49e includes a numerical value “11” indicating the acquired multiplicity as Multiplicity. The trouble information 49e also includes the job end time included in the acquired schedule information, as the scheduled end time (Scheduled_End_Time) of the job. In addition, the trouble information 49e includes the actual end time of the job as the end time (End_Time) of the job. Further, the trouble information 49d includes an assumed end delay factor as the assumed factor (Assumed_Factor).

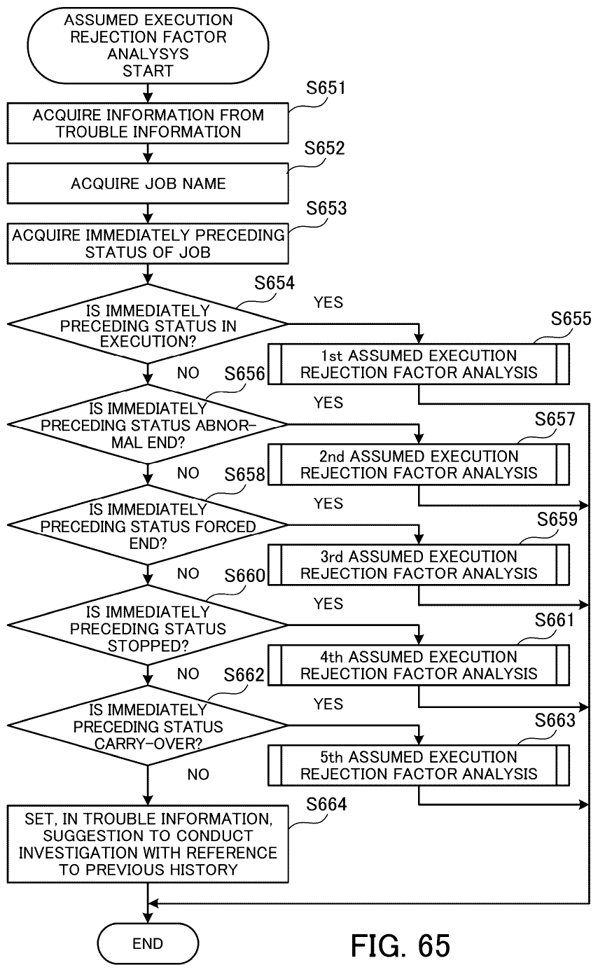

FIG. 50 is a flowchart illustrating an example procedure for the twelfth data group collection process. For example, in the case where the impact level is “High” and the trouble type is Execution Rejection, the twelfth data group collection process is performed. Hereinafter, the process illustrated in FIG. 50 will be described step by step.

[Step S539] The information collection unit 145 performs the multiplicity acquisition process.

[Step S540] The information collection unit 145 performs the schedule information acquisition.

[Step S541] The information collection unit 145 executes an assumed execution rejection factor analysis process. Details of the assumed execution rejection factor analysis process will be described later (see FIG. 65).

In the manner described above, in the case where the impact level is “High” and the trouble type is Execution Rejection, the multiplicity and the schedule information are collected, and the assumed execution rejection factor analysis is further performed. The collected twelfth data group (the multiplicity, the schedule information, and the result of the assumed execution rejection factor analysis) is set in the trouble information.

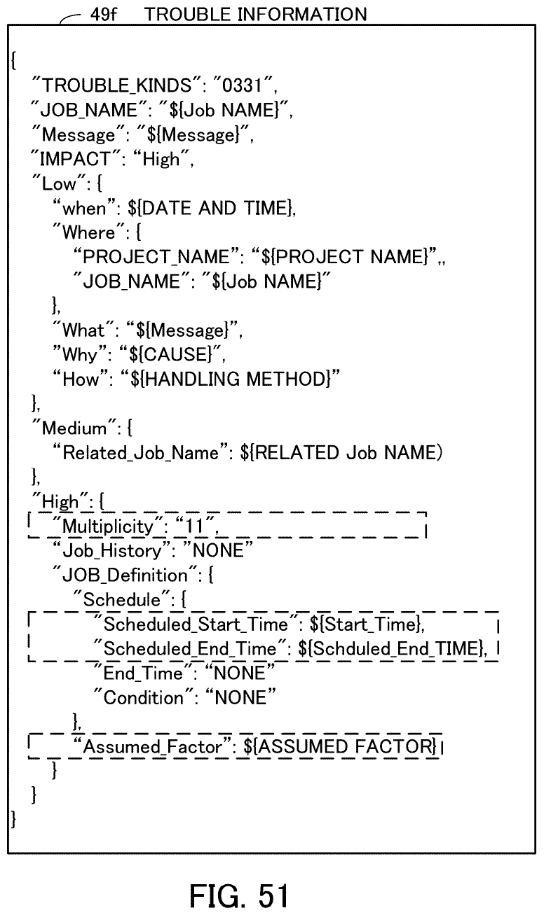

FIG. 51 illustrates an example of trouble information in which the twelfth data group is set. In trouble information 49f, the items within the ranges enclosed by dashed rectangles are those in which the multiplicity and the schedule information are set. For example, the trouble information 49f includes a numerical value “11” indicating the acquired multiplicity as Multiplicity. The trouble information 49f also includes the job start time included in the acquired schedule information, as the scheduled start time (Scheduled_Start_Time) of the job. In addition, the trouble information 49f includes the job end time included in the acquired schedule information, as the scheduled end time (Scheduled_End_Time) of the job. The trouble information 49f further includes an assumed execution rejection factor as the assumed factor (Assumed_Factor).

FIG. 52 is a flowchart illustrating an example procedure for the fifteenth data group collection process. For example, in the case where the impact level is “High” and the trouble type is Execution Skip, the fifteenth data group collection process is performed. Hereinafter, the process illustrated in FIG. 52 will be described step by step.

[Step S542] The information collection unit 145 performs the multiplicity acquisition process.

[Step S543] The information collection unit 145 performs the schedule information acquisition.

In the manner described above, in the case where the impact level is “High” and the trouble type is Execution Skip, the multiplicity and the schedule information are collected. The collected fifteenth data group (multiplicity and schedule information) is set in the trouble information.

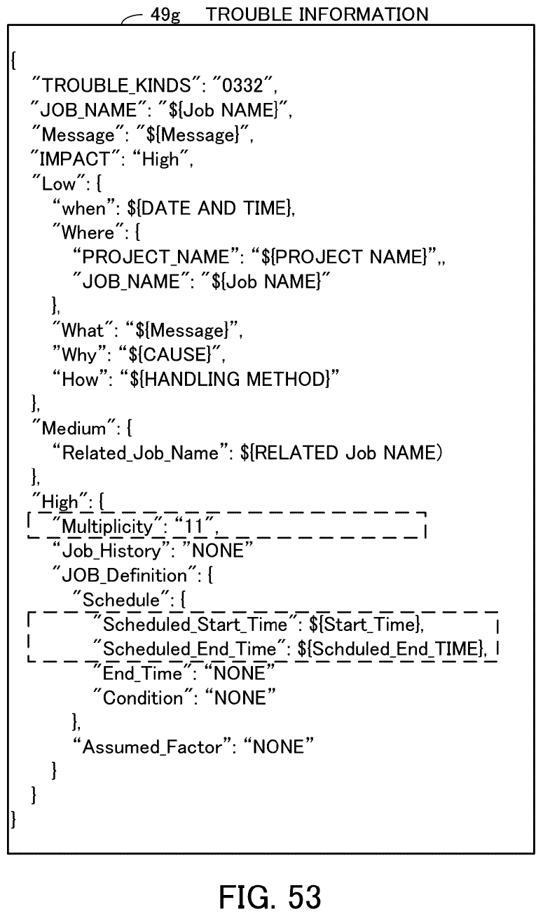

FIG. 53 illustrates an example of trouble information in which the fifteenth data group is set. In trouble information 49g, the items within the ranges enclosed by dashed rectangles are those in which the multiplicity and the schedule information are set. For example, the trouble information 49g includes a numerical value “11” indicating the acquired multiplicity as Multiplicity. The trouble information 49g also includes the job start time included in the acquired schedule information, as the scheduled start time (Scheduled_Start_Time) of the job. In addition, the trouble information 49g includes the job end time included in the acquired schedule information, as the scheduled end time (Scheduled_End_Time) of the job.

Next, a procedure for collecting various types of information specified by the information collection range in the case where the impact level is “High” will be described.

FIG. 54 is a flowchart illustrating an example procedure for the multiplicity acquisition process. Hereinafter, the process illustrated in FIG. 54 will be described step by step.

[Step S551] The information collection unit 145 acquires a timestamp. For example, the information collection unit 145 extracts, from an error alert message, a timestamp indicating the output time of the message.

[Step S552] The information collection unit 145 causes the job execution management unit 130 to execute a job multiplicity acquisition command. For example, the information collection unit 145 transmits, to the job execution management unit 130, a job multiplicity acquisition command using a timestamp as an argument, in order to obtain the multiplicity of jobs in a unit time zone including the time indicated by the timestamp. In response to the multiplicity acquisition command, the job execution management unit 130 retrieves a record corresponding to the unit time zone from the state-specific job count record table 112. Then, the job execution management unit 130 returns the acquired record.

[Step S553] The information collection unit 145 sets, in the trouble information, the multiplicity of jobs in the unit time zone in which the troubled job was executed.

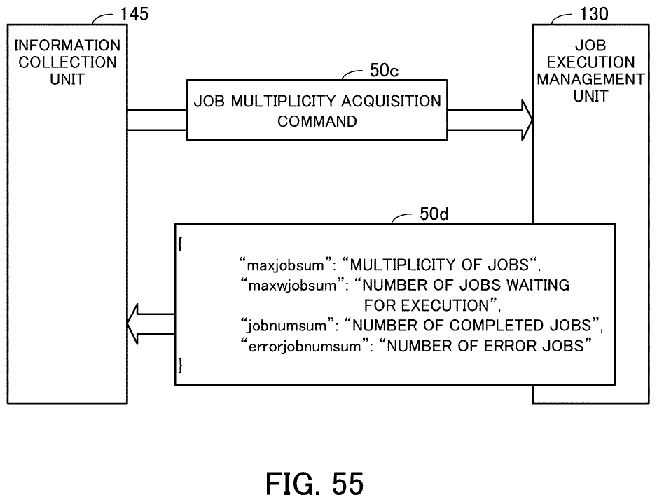

FIG. 55 illustrates an example of response data returned in response to a multiplicity acquisition command. When a multiplicity acquisition command 50c is transmitted from the information collection unit 145 to the job execution management unit 130, response data 50d as illustrated in FIG. 55 is returned from the job execution management unit 130. The response data 50d includes information on the number of jobs for each state within the unit time zone in which the troubled job was executed. Information included in the response data 50d includes the multiplicity of jobs as the item “maxjobsum”.

FIG. 56 is a flowchart illustrating an example procedure for the previous history acquisition process. Hereinafter, the process illustrated in FIG. 56 will be described step by step.

[Step S561] The information collection unit 145 acquires a timestamp. For example, the information collection unit 145 extracts, from an error alert message, a timestamp indicating the output time of the message.

[Step S562] The information collection unit 145 acquires the job name of the job in which the trouble has occurred. For example, the information collection unit 145 extracts the job name of the troubled job from the error alert message.

[Step S563] The information collection unit 145 causes the job execution management unit 130 to execute a job execution history acquisition command. For example, the information collection unit 145 transmits, to the job execution management unit 130, an execution history acquisition command using the timestamp and the job name as arguments, in order to obtain the execution history of the job executed at the time indicated by the timestamp, the job being identified by the job name. In response to the execution history acquisition command, the job execution management unit 130 retrieves a record corresponding to the combination of the timestamp and the job name from the job execution history table 113. Then, the job execution management unit 130 returns the acquired record as a response.

[Step S564] The information collection unit 145 sets the previous history of the job in the trouble information.

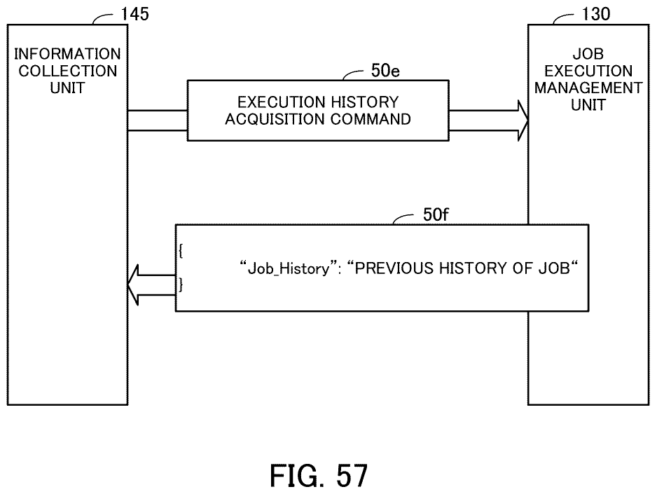

FIG. 57 illustrates an example of response data returned in response to an execution history acquisition command. When an execution history acquisition command 50e is transmitted from the information collection unit 145 to the job execution management unit 130, response data 50f as illustrated in FIG. 57 is returned from the job execution management unit 130. The response data 50f includes information on the execution history of the job in which the trouble has occurred. For example, the response data 50f includes the previous history of the job as the item “Job_History”.

FIG. 58 is a flowchart illustrating an example procedure for the schedule information acquisition process. Hereinafter, the process illustrated in FIG. 58 will be described step by step.

[Step S571] The information collection unit 145 acquires the job name of the job in which the trouble has occurred. For example, the information collection unit 145 extracts the job name of the troubled job from an error alert message.

[Step S572] The information collection unit 145 causes the job execution management unit 130 to execute a job schedule information acquisition command. For example, the information collection unit 145 transmits, to the job execution management unit 130, a schedule information acquisition command using the job name as an argument, in order to obtain the schedule information of the troubled job. In response to the schedule information acquisition command, the job execution management unit 130 retrieves each record corresponding to the specified job name from the job execution history table 113. Then, the job execution management unit 130 returns the acquired record as a response.

[Step S573] The information collection unit 145 determines an information collection range corresponding to the trouble that has occurred. For example, the information collection unit 145 determines the information collection range based on the combination of the trouble type and the impact level set in the trouble information. If the information collection range is the sixth data group, the information collection unit 145 advances the process to step S574. If the information collection range is the ninth data group, the information collection unit 145 advances the process to step S575. If the information collection range is the twelfth data group or the fifteenth data group, the information collection unit 145 advances the process to step S576.

[Step S574] The information collection unit 145 sets the scheduled start time and the start condition in the trouble information, on the basis of the acquired schedule information. Thereafter, the information collection unit 145 completes the schedule information acquisition process.

[Step S575] The information collection unit 145 sets the scheduled end time and the end time in the trouble information, on the basis of the acquired schedule information. Thereafter, the information collection unit 145 completes the schedule information acquisition process.

[Step S576] The information collection unit 145 sets the scheduled start time and the scheduled end time in the trouble information, on the basis of the acquired schedule information. Thereafter, the information collection unit 145 completes the schedule information acquisition process.

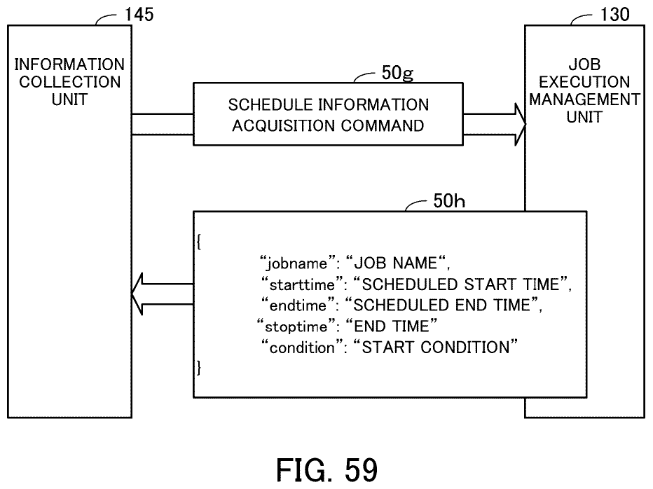

FIG. 59 illustrates an example of response data returned in response to a schedule information acquisition command. When a schedule information acquisition command 50g is transmitted from the information collection unit 145 to the job execution management unit 130, response data 50h as illustrated in FIG. 59 is returned from the job execution management unit 130. The response data 50h includes information on the execution schedule and the execution result of the job in which the trouble has occurred. For example, the response data 50h includes a scheduled start time as the item “starttime”, a scheduled end time as the item “endtime”, an end time as the item “stoptime”, and a start condition as the item “condition”.

The following describes the assumed start delay factor analysis process in detail with reference to FIGS. 60 to 63.

FIG. 60 is a flowchart illustrating an example procedure for an assumed start delay factor analysis process. Hereinafter, the process illustrated in FIG. 60 will be described step by step.

[Step S601] The information collection unit 145 acquires the start condition of the job from the trouble information.

[Step S602] The information collection unit 145 analyzes the start condition of the job. If the start condition is the normal end of a preceding job only, the information collection unit 145 advances the process to step S603. If the start condition is the occurrence of a predetermined message event only, the information collection unit 145 advances the process to step S604. If the start condition is both the normal end of a preceding job and the occurrence of a predetermined message event, the information collection unit 145 advances the process to step S605.

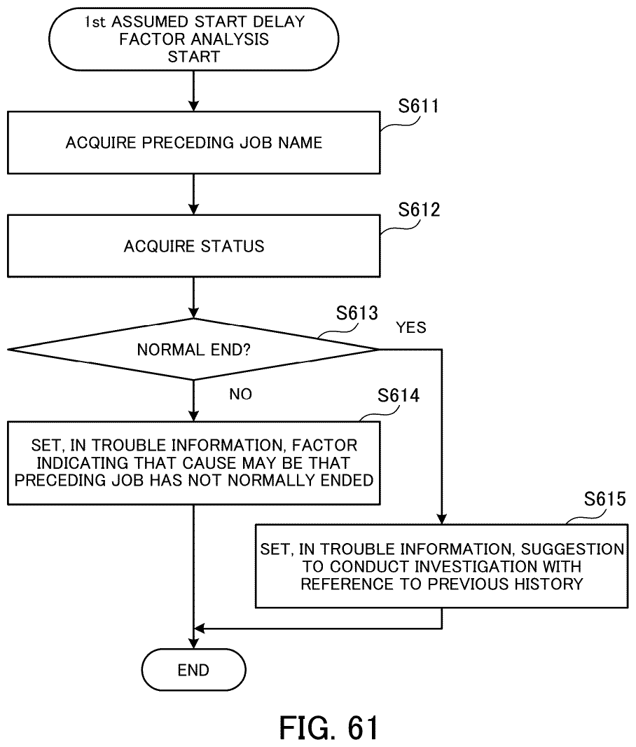

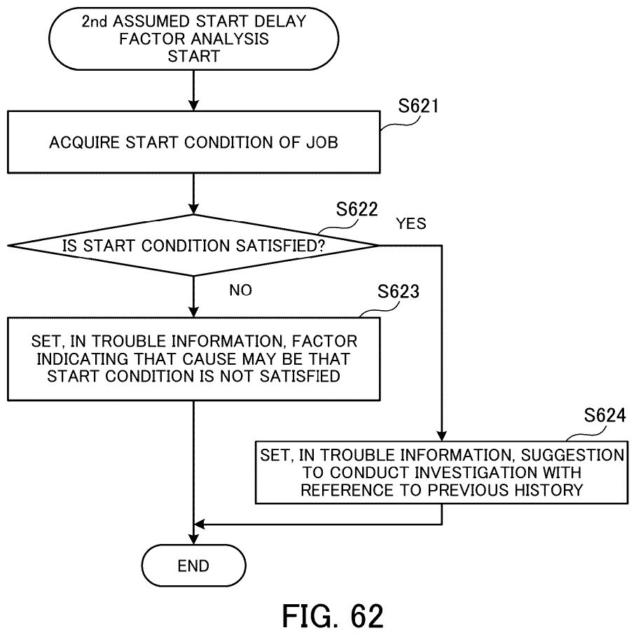

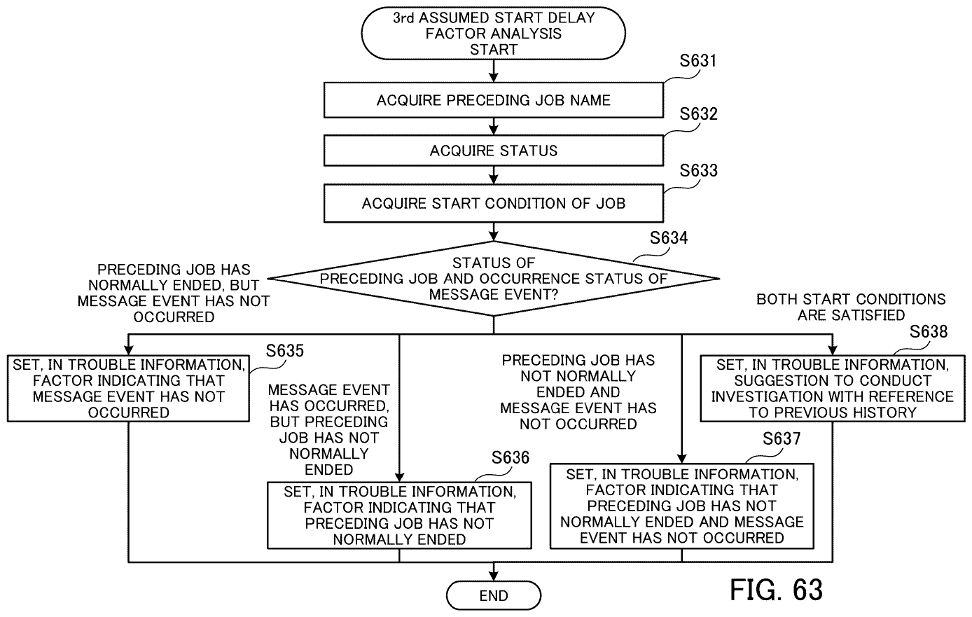

(Step S603) The information collection unit 145 performs a first assumed start delay factor analysis process. Details of the first assumed start delay factor analysis process will be described later (see FIG. 61). Thereafter, the information collection unit 145 completes the assumed start delay factor analysis process.

[Step S604] The information collection unit 145 performs a second assumed start delay factor analysis process. Details of the second assumed start delay factor analysis process will be described later (see FIG. 62). Thereafter, the information collection unit 145 completes the assumed start delay factor analysis process.

[Step S605] The information collection unit 145 performs a third assumed start delay factor analysis process. Details of the third assumed start delay factor analysis process will be described later (see FIG. 63). Thereafter, the information collection unit 145 completes the assumed start delay factor analysis process.

As described above, the assumed start delay factor analysis process differs depending on the start condition.

FIG. 61 is a flowchart illustrating an example procedure for the first assumed start delay factor analysis process. Hereinafter, the process illustrated in FIG. 61 will be described step by step.

[Step S611] The information collection unit 145 causes the job execution management unit 130 to execute a related job name acquisition command, to thereby acquire the job name of the preceding job.

[Step S612] The information collection unit 145 acquires the status of the preceding job. For example, the information collection unit 145 causes the job execution management unit 130 to execute a status acquisition command using the job name of the preceding job as an argument. In response to the acquisition command, the job execution management unit 130 returns a response including the status information of the preceding job. The acquired status information includes information indicating whether the preceding job has normally ended.

[Step S613] The information collection unit 145 determines whether the preceding job has normally ended. If the preceding job has normally ended, the information collection unit 145 advances the process to step S615. If the preceding job has not normally ended, the information collection unit 145 advances the process to step S614.

[Step S614] The information collection unit 145 sets, in the trouble information, an assumed start delay factor indicating that the cause may be that the preceding job has not normally ended, as an analysis result. For example, as the assumed start delay factor, the following message may be set: “The preceding job that is a start condition has not normally ended. Therefore, the cause may be that the preceding job has not normally ended.” Thereafter, the information collection unit 145 completes the first assumed start delay factor analysis process.

[Step S615] The information collection unit 145 sets, in the trouble information, a suggestion to conduct an investigation with reference to the previous history as a result of the assumed start delay factor analysis.

As described above, in the case where the start condition is a normal end of the preceding job only, an assumed start delay factor is determined based on whether the preceding job has been normally ended.

FIG. 62 is a flowchart illustrating an example procedure for the second assumed start delay factor analysis process. Hereinafter, the process illustrated in FIG. 62 will be described step by step.

[Step S621] The information collection unit 145 acquires the start condition (for example, the occurrence state of a prerequisite event) of the job from the trouble information.

[Step S622] The information collection unit 145 determines whether the start condition is satisfied. If the start condition is satisfied, the information collection unit 145 advances the process to step S624. If the start condition is not satisfied, the information collection unit 145 advances the process to step S623.

[Step S623] The information collection unit 145 sets, in the trouble information, an assumed start delay factor indicating that the cause may be that the start condition is not satisfied, as an analysis result. For example, as the assumed start delay factor, the following message is set: “The message event that is a start condition has not occurred. Therefore, the cause may be that the message event has not occurred.” Thereafter, the information collection unit 145 completes the second assumed start delay factor analysis process.

[Step S624] The information collection unit 145 sets, in the trouble information, a suggestion to conduct an investigation with reference to the previous history, as a result of the assumed start delay factor analysis.

As described above, in the case where the start condition is the occurrence of a predetermined message event only, an assumed start delay factor is determined based on whether the message event has occurred.

FIG. 63 is a flowchart illustrating an example procedure for the third assumed start delay factor analysis process. Hereinafter, the process illustrated in FIG. 63 will be described step by step.

[Step S631] The information collection unit 145 causes the job execution management unit 130 to execute a related job name acquisition command, to thereby acquire the job name of the preceding job.

[Step S632] The information collection unit 145 acquires the status of the preceding job. The acquired status information includes information indicating whether the preceding job has normally ended.

[Step S633] The information collection unit 145 acquires the start condition (for example, the occurrence state of a prerequisite event) of the job from the trouble information.

[Step S634] The information collection unit 145 analyzes the status of the preceding job and the occurrence state of the predetermined message event. If the preceding job has been normally ended but the predetermined message event has not occurred, the information collection unit 145 advances the process to step S635. If the predetermined message event has occurred but the preceding job has not normally ended, the information collection unit 145 advances the process to step S636. If the preceding job has not normally ended and the predetermined message event has not occurred, the information collection unit 145 advances the process to step S637. If the preceding job has not normally ended and the predetermined message event has not occurred, the information collection unit 145 advances the process to step S637. If both of the two start conditions that the preceding job has normally ended and the predetermined message event has occurred are satisfied, the information collection unit 145 advances the process to step S638.

[Step S635] The information collection unit 145 sets, in the trouble information, an assumed start delay factor indicating that the cause may be that the predetermined message event has not occurred, as an analysis result. For example, as the assumed start delay factor, the following message is set: “The preceding job that is a start condition normally ended at XX:YY:ZZ, but a message event, which is another start condition, has not occurred. Therefore, the cause may be that the message event has not occurred.” Thereafter, the information collection unit 145 completes the third assumed start delay factor analysis process.

[Step S636] The information collection unit 145 sets, in the trouble information, an assumed start delay factor indicating that the cause may be that the preceding job has not normally ended, as an analysis result. For example, as the assumed start delay factor, the following message is set: “The message event that is a start condition occurred at XX:YY:ZZ, but the preceding job, which is another start condition, has not normally ended. Therefore, the cause may be that the preceding job has not normally ended.” Thereafter, the information collection unit 145 completes the third assumed start delay factor analysis process.

[Step S637] The information collection unit 145 sets, in the trouble information, an assumed start delay factor indicating that the cause may be that the preceding job has not normally ended and the predetermined message event has not occurred, as an analysis result. For example, as the assumed start delay factor, the following message may be set: “Neither the preceding job nor the message event that are start conditions has normally ended or occurred.” Thereafter, the information collection unit 145 completes the third assumed start delay factor analysis process.

[Step S638] The information collection unit 145 sets, in the trouble information, a suggestion to conduct an investigation with reference to the previous history, as a result of the assumed start delay factor analysis.

As described above, an assumed start delay factor is determined based on whether each of the two start conditions is satisfied.

Next, the assumed end delay factor analysis process will be described in detail.

FIG. 64 is a flowchart illustrating an example procedure for the assumed end delay factor analysis process. Hereinafter, the process illustrated in FIG. 64 will be described step by step.

[Step S641] The information collection unit 145 causes the job execution management unit 130 to execute a related job name acquisition command, to thereby acquire the job name of the job in which the trouble has occurred.

[Step S642] The information collection unit 145 acquires the status of the troubled job immediately preceding the current status.

[Step S643] The information collection unit 145 determines whether the immediately preceding status is Start Delay. If the immediately preceding status is Start Delay, the information collection unit 145 advances the process to step S644. If the immediately preceding status is not Start Delay, the information collection unit 145 advances the process to step S645.

[Step S644] The information collection unit 145 sets, in the trouble information, an assumed end delay factor indicating that the cause may be a start delay of the troubled job, as an analysis result. For example, as the assumed end delay factor, the following message is set: “A start delay of the job causes a delay in the end of the job.” Thereafter, the information collection unit 145 completes the assumed end delay factor analysis process.

[Step S645] The information collection unit 145 determines whether the troubled job is a group job. If the job is a group job, the information collection unit 145 advances the process to step S646. If the job is not a group job, the information collection unit 145 advances the process to step S649.

[Step S646] The information collection unit 145 causes the job execution management unit 130 to execute a job status acquisition command using the job name of each job in the group as an argument. The job execution management unit 130 returns a response including the status information of each job in the group to the information collection unit 145.

[Step S647] The information collection unit 145 determines based on the status information of each job in the group whether there is at least one job in which an end delay has occurred. If at least one job in which an end delay has occurred is found, the information collection unit 145 advances the process to step S648. If no job in which an end delay has occurred is found, the information collection unit 145 advances the process to step S649.

[Step S648] The information collection unit 145 sets, in the trouble information, an assumed end delay factor indicating that the cause may be a delay in one or more jobs in the group. Thereafter, the information collection unit 145 completes the assumed end delay factor analysis process.

[Step S649] The information collection unit 145 sets, in the trouble information, a suggestion to conduct an investigation with reference to the previous history, as a result of the assumed end delay factor analysis.

As a result, a factor such as a preceding job not having ended or a delay occurring in one or more jobs in the group is set as an assumed end delay factor in the trouble information.

The following describes the assumed execution rejection factor analysis process in detail with reference to FIGS. 65 to 70.

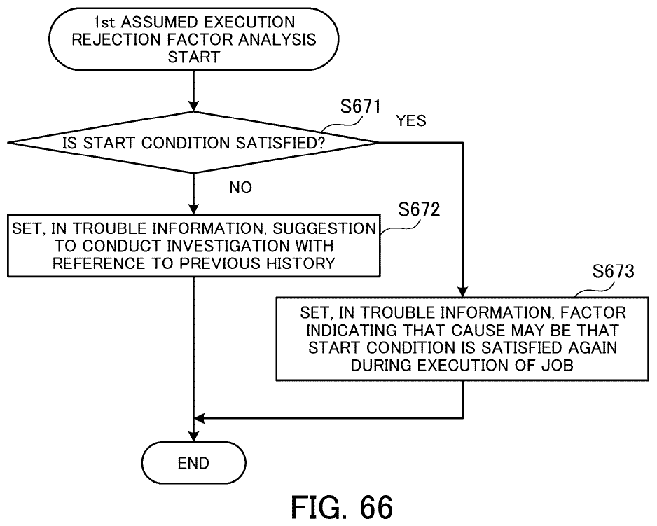

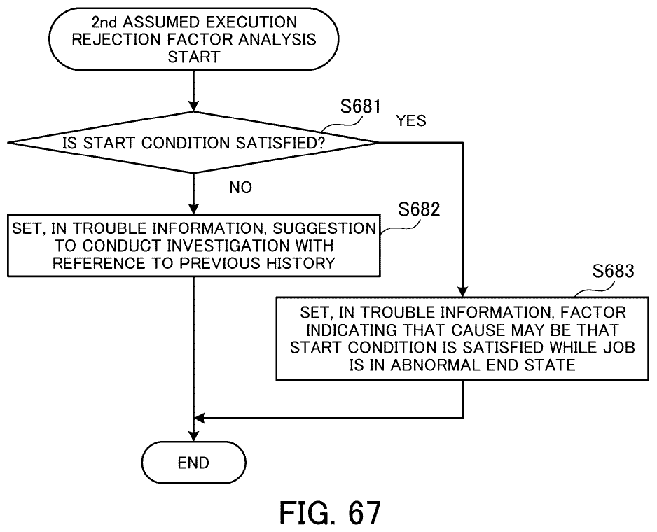

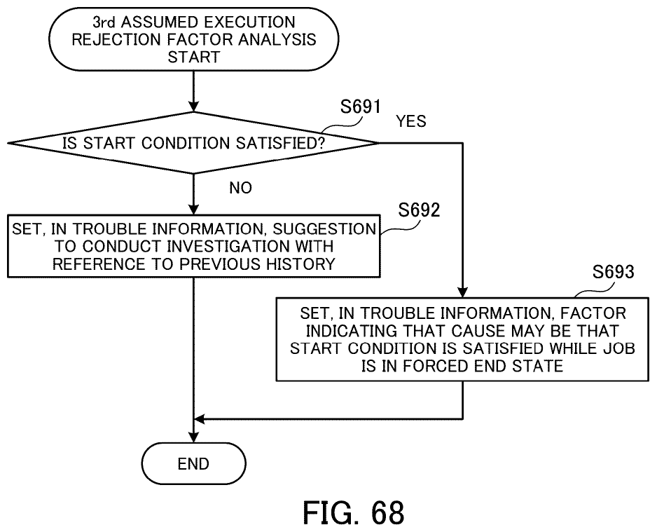

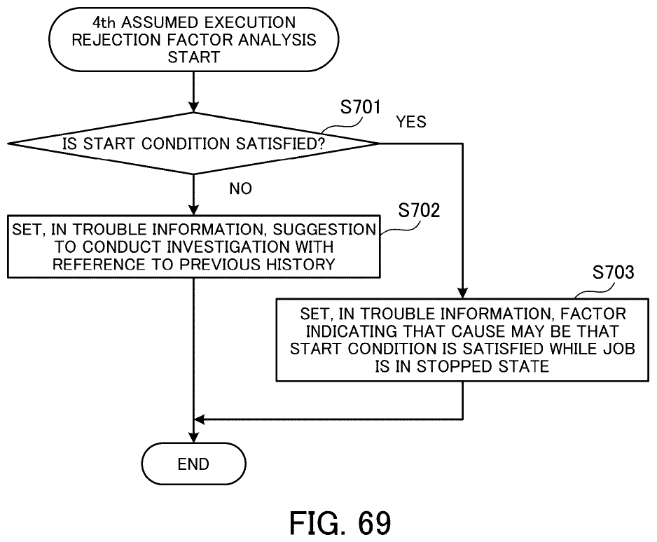

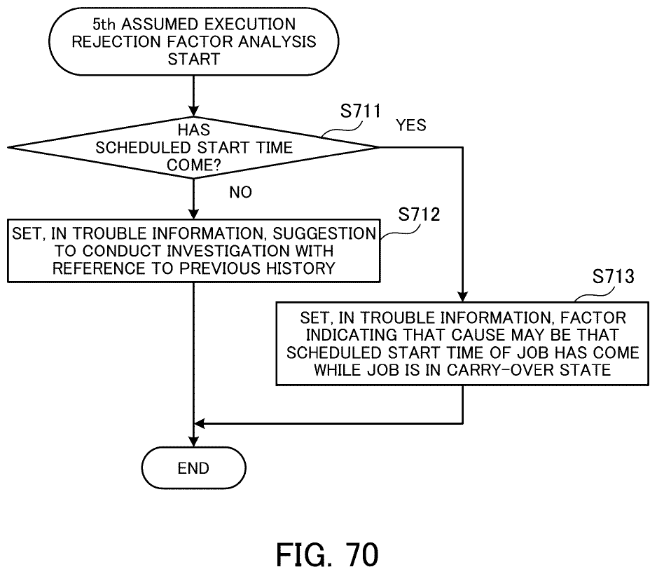

FIG. 65 is a flowchart illustrating an example procedure for the assumed execution rejection factor analysis process. Hereinafter, the process illustrated in FIG. 65 will be described step by step.

[Step S651] The information collection unit 145 acquires schedule information (scheduled start time, start condition, etc.) from the trouble information.

[Step S652] The information collection unit 145 acquires the job name of the job in which the trouble has occurred, from the trouble information.

[Step S653] The information collection unit 145 acquires, from the job execution management unit 130, the status of the troubled job immediately preceding the current status, using the job name as an argument.

[Step S654] The information collection unit 145 determines whether the status of the troubled job immediately preceding the current status is “In Execution”. If the status is “In Execution”, the information collection unit 145 advances the process to step S655. If the status is not “In Execution”, the information collection unit 145 advances the process to step S656.

[Step S655] The information collection unit 145 performs a first assumed execution rejection factor analysis process. Details of the first assumed execution rejection factor analysis process will be described later (see FIG. 66). Thereafter, the information collection unit 145 completes the assumed execution rejection factor analysis process.

[Step S656] The information collection unit 145 determines whether the status of the troubled job immediately preceding the current status is “Abnormal End”. If the status is Abnormal End, the information collection unit 145 advances the process to step S657. If the status is not Abnormal End, the information collection unit 145 advances the process to step S658.

[Step S657] The information collection unit 145 executes a second assumed execution rejection factor analysis process. Details of the second assumed execution rejection factor analysis process will be described later (see FIG. 67). Thereafter, the information collection unit 145 completes the assumed execution rejection factor analysis process.

[Step S658] The information collection unit 145 determines whether the status of the troubled job immediately preceding the current status is Forced End. If the status is Forced End, the information collection unit 145 advances the process to step S659. If the status is Forced End, the information collection unit 145 advances the process to step S660.

[Step S659] The information collection unit 145 performs a third assumed execution rejection factor analysis process. Details of the third assumed execution rejection factor analysis process will be described later (see FIG. 68). Thereafter, the information collection unit 145 completes the assumed execution rejection factor analysis process.

[Step S660] The information collection unit 145 determines whether the immediately preceding status of the troubled job is “Stopped”. If the status is Stopped, the information collection unit 145 advances the process to step S661. If the status is not Stopped, the information collection unit 145 advances the process to step S662.

[Step S661] The information collection unit 145 performs a fourth assumed execution rejection factor analysis process. Details of the fourth assumed execution rejection factor analysis process will be described later (see FIG. 69). Thereafter, the information collection unit 145 performs the assumed execution rejection factor analysis process.

[Step S662] The information collection unit 145 determines whether the status of the troubled job immediately preceding the current status is Carry-Over. If the status is Carry-Over, the information collection unit 145 advances the process to step S663. If the status is not Carry-Over, the information collection unit 145 advances the process to step S664.

[Step S663] The information collection unit 145 performs a fifth assumed execution rejection factor analysis process. Details of the fifth assumed execution rejection factor analysis process will be described later (see FIG. 70). Thereafter, the information collection unit 145 completes the assumed execution rejection factor analysis process.

[Step S664] The information collection unit 145 sets, in the trouble information, a suggestion to conduct an investigation with reference to the previous history, as a result of the assumed execution rejection factor analysis.

As described above, the procedure for the assumed execution rejection factor analysis depends on the status of the troubled job immediately preceding the current status.

FIG. 66 is a flowchart illustrating an example procedure for the first assumed execution rejection factor analysis process. Hereinafter, the process illustrated in FIG. 66 will be described step by step.

[Step S671] The information collection unit 145 determines whether the job in which the trouble has occurred satisfies the start condition. If the start condition is satisfied, the information collection unit 145 advances the process to step S673. If the start condition is not satisfied, the information collection unit 145 advances the process to step S672.

[Step S672] The information collection unit 145 sets, in the trouble information, a suggestion to conduct an investigation with reference to the previous history, as a result of the assumed execution rejection factor analysis. Thereafter, the information collection unit 145 completes the first assumed execution rejection assumed analysis process.

[Step S673] The information collection unit 145 sets, in the trouble information, an assumed execution rejection factor indicating that the cause may be that the start condition of the job is satisfied again during the execution of the job, as an analysis result.

As described above, in the case where the start condition of a job is satisfied while the previous execution of the job has not yet ended, an assumed execution rejection factor indicating this situation is set.

FIG. 67 is a flowchart illustrating an example procedure for the second assumed execution rejection factor analysis process. Hereinafter, the process illustrated in FIG. 67 will be described step by step.

[Step S681] The information collection unit 145 determines whether the job in which the trouble has occurred satisfies the start condition. If the start condition is satisfied, the information collection unit 145 advances the process to step S683. If the start condition is not satisfied, the information collection unit 145 advances the process to step S682.

[Step S682] The information collection unit 145 sets, in the trouble information, a suggestion to conduct an investigation with reference to the previous history, as a result of the assumed execution rejection factor analysis. Thereafter, the information collection unit 145 completes the second assumed execution rejection factor analysis process.

[Step S683] The information collection unit 145 sets, in the trouble information, an assumed execution rejection factor indicating that the cause may be that the start condition of the job is satisfied while the job is in an abnormal end state, as an analysis result.

As described above, in the case where the start condition of a job is satisfied while the previous execution of the job has abnormally ended, an assumed execution rejection factor indicating the situation is set.

FIG. 68 is a flowchart illustrating an example procedure for the third assumed execution rejection factor analysis process. Hereinafter, the process illustrated in FIG. 68 will be described step by step.

[Step S691] The information collection unit 145 determines whether the job in which the trouble has occurred satisfies the start condition. If the start condition is satisfied, the information collection unit 145 advances the process to step S693. If the start condition is not satisfied, the information collection unit 145 advances the process to step S692.

[Step S692] The information collection unit 145 sets, in the trouble information, a suggestion to conduct an investigation with reference to the previous history, as a result of the assumed execution rejection factor analysis. Thereafter, the information collection unit 145 completes the third assumed execution rejection factor analysis process.

[Step S693] The information collection unit 145 sets, in the trouble information, an assumed execution rejection factor indicating that the cause may be that the start condition of the job is satisfied while the job is in the forced end state, as an analysis result.

As described above, in the case where the start condition of a job is satisfied even though the previous execution of the job has been forcibly ended, an assumed execution rejection factor indicating this situation is set.

FIG. 69 is a flowchart illustrating an example procedure for the fourth assumed execution rejection factor analysis process. Hereinafter, the process illustrated in FIG. 69 will be described step by step.

[Step S701] The information collection unit 145 determines whether the job in which the trouble has occurred satisfies the start condition. If the start condition is satisfied, the information collection unit 145 advances the process to step S703. If the start condition is not satisfied, the information collection unit 145 advances the process to step S702.

[Step S702] The information collection unit 145 sets, in the trouble information, a suggestion to conduct an investigation with reference to the previous history, as a result of the assumed execution rejection factor analysis. Thereafter, the information collection unit 145 completes the fourth assumed execution rejection factor analysis process.

[Step S703] the information collection unit 145 sets, in the trouble information, an assumed execution rejection factor indicating that the cause may be that the start condition of the job is satisfied while the job is in the execution stopped state, as an analysis result.

As described above, in the case where the start condition of a job is satisfied even though the previous execution of the job has stopped, an assumed execution rejection factor indicating this situation is set.

FIG. 70 is a flowchart illustrating an example procedure for the fifth assumed execution rejection factor analysis process. Hereinafter, the process illustrated in FIG. 70 will be described step by step.

[Step S711] The information collection unit 145 determines whether the scheduled start time of the job in which the trouble has occurred has come. If the scheduled start time has come, the information collection unit 145 advances the process to step S713. If the scheduled start time has not come, the information collection unit 145 advances the process to step S712.

[Step S712] The information collection unit 145 sets, in the trouble information, a suggestion to conduct an investigation with reference to the previous history, as a result of the assumed execution rejection factor analysis. Thereafter, the information collection unit 145 completes the fifth assumed execution rejection factor analysis process.

[Step S713] The information collection unit 145 sets, in the trouble information, an assumed execution rejection factor indicating that the cause may be that the scheduled start time of the job has come while the job is in the carry-over state, as an analysis result.

In the manner described above, in the case where the scheduled start time of a job has come while the previous execution of the job is a carry-over, an assumed execution rejection factor indicating this situation is set.

As described above, trouble information in which useful information collected according to a trouble type and an impact level is set is generated.

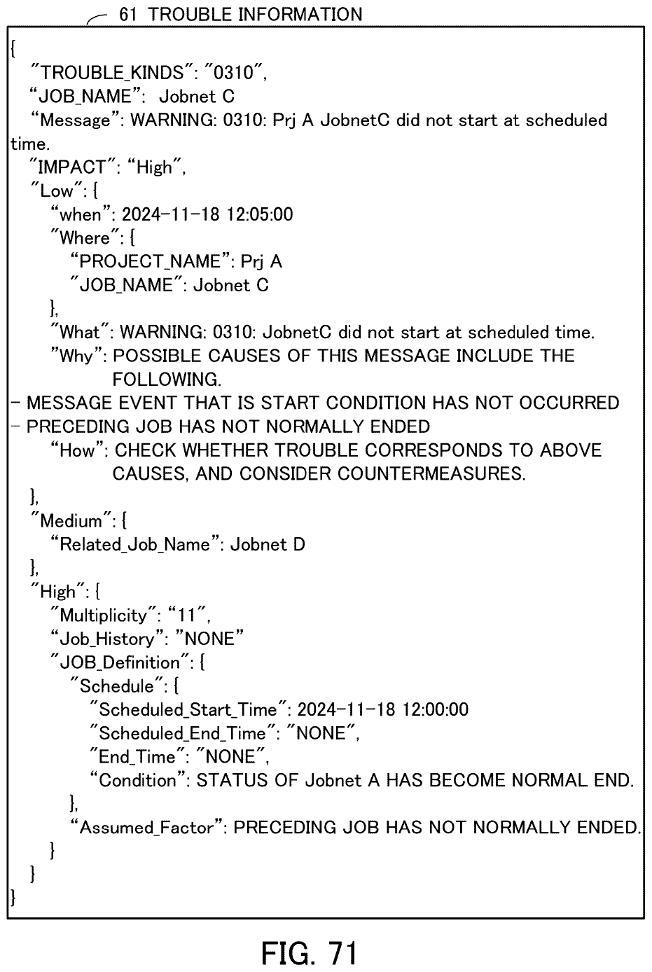

FIG. 71 illustrates an example of trouble information in which information collected according to a trouble type and an impact level is set. In trouble information 61, information useful for analyzing a trouble having the trouble type of Start Delay (type code “0310”) and the impact level of “High” is set.

Incident information is generated based on the trouble information 61, and the incident information is transmitted to the ITSM server 32. In response to a request from the terminal device 30, the ITSM server 32 transmits display data indicating the incident information to the terminal device 30. Then, an incident display screen is displayed on the terminal device 30.

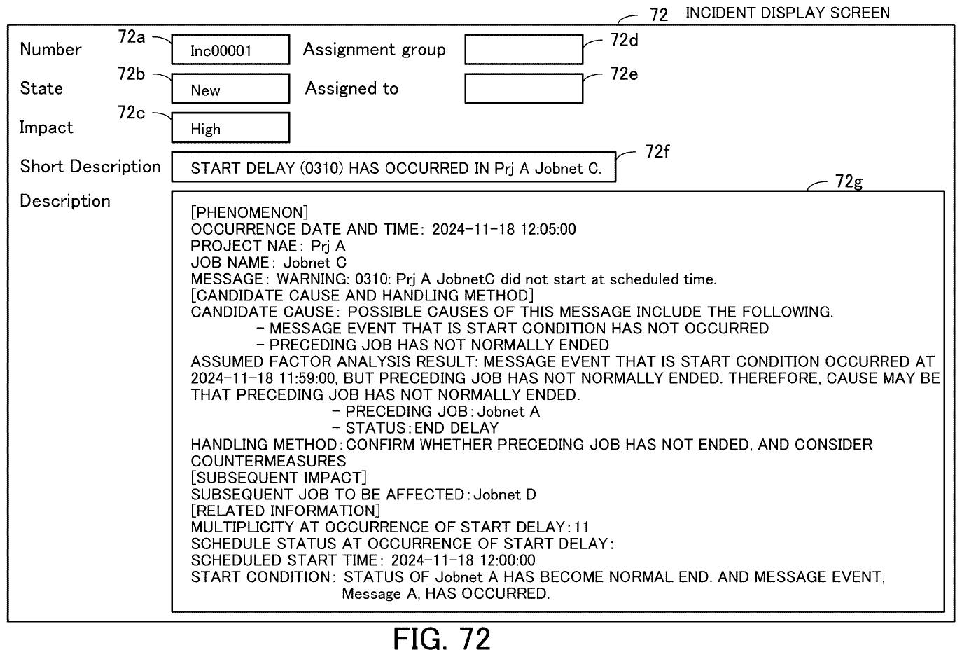

FIG. 72 illustrates an example of an incident display screen. An incident display screen 72 includes, for example, an incident number display section 72a, a status display section 72b, an impact level display section 72c, a handling group display section 72d, a handling person display section 72e, a short description display section 72f, and a detailed description display section 72g.

The incident number display section 72 a displays the identification number of an incident. The status display section 72b displays the state of the incident (whether the incident is new, is being handled, is resolved, or another). The impact level display section 72c displays the impact level of a trouble that has occurred. The handling group display section 72d displays the name of a group assigned the trouble indicated in the incident. The handling person display section 72e displays the name of a person assigned the trouble. The short description display section 72f displays a sentence briefly describing the details of the trouble. 418 The detailed description display section 72g displays information describing the details of the trouble. For example, the detailed description display section 72g displays the occurrence date and time, the project name, the job name, and an output message. In addition, the detailed description display section 72g displays a candidate cause of the trouble, the result of an assumed factor analysis, a handling method, and others. Further, the detailed description display section 72g displays the job name of a subsequent job to be affected by the trouble as a range of impact of the trouble.

The detailed description display section 72g also displays other related information. In the case where the trouble type is Start Delay, the related information includes the multiplicity at the time of the start delay occurrence, the schedule status at the time of the start delay occurrence, the scheduled start time of the job, the start condition, and others.

By referring to the above incident display screen 72, the person in charge of handling the trouble is able to confirm the information useful for handling the trouble. As a result, the time to investigate the trouble is shortened.

According to one aspect, it is possible to reduce the time to investigate a trouble.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a process comprising:
acquiring a message including a job name of a job in which a trouble has occurred and type information indicating a type of the trouble;
determining an impact level of the trouble on a system executing the job, based on a combination of the job name and the type information;
determining an attribute of information to be acquired, based on the determined impact level; and
acquiring, from first information relating to the job, second information having the determined attribute.

2. The non-transitory computer-readable storage medium according to claim 1, wherein the determining of the attribute of the information to be acquired includes determining the attribute, based on a combination of the type information and the impact level.

3. The non-transitory computer-readable storage medium according to claim 1, wherein the process further includes acquiring information on a handling method corresponding to the type information, from handling method information indicating a handling method for each of a plurality of troubles.

4. The non-transitory computer-readable storage medium according to claim 1, wherein the process further includes analyzing a factor that has caused the trouble, based on the acquired second information.

5. The non-transitory computer-readable storage medium according to claim 4, wherein the analyzing of the factor includes analyzing the factor that has caused the trouble, in response to the impact level being a predetermined value.

6. The non-transitory computer-readable storage medium according to claim 4, wherein the process further includes outputting trouble information including the acquired second information and a result of analyzing the factor.

7. An information processing method comprising:
acquiring, by a processor, a message including a job name of a job in which a trouble has occurred and type information indicating a type of the trouble;
determining, by the processor, an impact level of the trouble on a system executing the job, based on a combination of the job name and the type information;
determining, by the processor, an attribute of information to be acquired, based on the determined impact level; and
acquiring, by the processor, from first information relating to the job, second information having the determined attribute.

8. An information processing system comprising:
a system configured to output, in response to a trouble occurring during execution of a job, a message including a job name of the job and type information indicating a type of the trouble; and
an information processing apparatus configured to
acquire the message,
determine an impact level of the trouble on the system executing the job, based on a combination of the job name and the type information,
determine an attribute of information to be acquired, based on the determined impact level, and
acquire, from first information relating to the job, second information having the determined attribute.
